(19) United States
(12) Patent Application Publication
(10) Pub. No.: US 2025/0182925 A1
(43) Pub. Date: Jun. 5, 2025

(54) LAMINATE FOR SOLID STATE ELECTROCHEMICAL ELEMENT, SOLID STATE ELECTROCHEMICAL ELEMENT, ELECTRIC DEVICE, AND MOBILE OBJECT

(71) Applicants: Kayato Ohya, Kanagawa (JP); Ryuji Higashi, Kanagawa (JP)

(72) Inventors: Kayato Ohya, Kanagawa (JP); Ryuji Higashi, Kanagawa (JP)

(73) Assignee: Ricoh Company, Ltd., Tokyo (JP)

(21) Appl. No.: 18/960,606

(22) Filed: Nov. 26, 2024

(30) Foreign Application Priority Data
Nov. 30, 2023 (JP) 2023-202573

(51) Int. Cl. H01B 3/44; H01B 17/56; H01M 4/36; H01M 10/0562

(52) U.S. Cl. CPC H01B 3/447; H01B 17/56; H01M 4/364; H01M 10/0562; H01M 2220/20

(57) ABSTRACT

A laminate for a solid state electrochemical element includes a sulfide solid electrolyte-containing layer and an insulating resin layer at least partially in contact with the sulfide solid electrolyte-containing layer, wherein the insulating resin layer has a porous structure and includes a structural unit represented by the following Chemical Formula 1 or Chemical Formula 2,

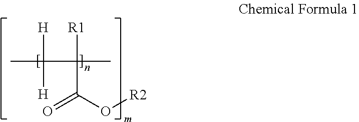

where R1 represents a hydrogen atom or a methyl group and R2 represents a polyester chain or an acrylic oligomer ester derivative,

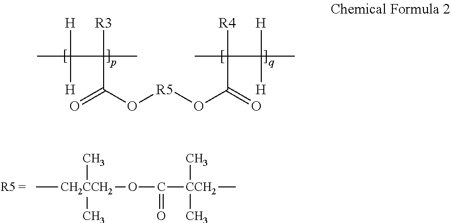

where R3 and R4 each, independently, represent hydrogen atoms or methyl groups.

### CROSS-REFERENCE TO RELATED APPLICATIONS

This patent application is based on and claims priority pursuant to 35 U.S.C. § 119 to Japanese Patent Application No. 2023-202573, filed on Nov. 30, 2023, in the Japan Patent Office, the entire disclosure of which is hereby incorporated by reference herein.

### BACKGROUND

### Technical Field

The present disclosure is related to a laminate for a solid state electrochemical element, a solid state electrochemical element, an electric device, and a mobile object.

### Description of the Related Art

Solid state secondary batteries are superior in terms of safety compared with conventional lithium-ion secondary batteries because they are resistant to temperature changes and have a lower risk of ignition. Additionally, they can be rapidly charged, which enhances performance. For these reasons, the demand for their use in electric vehicles and other applications is expected to expand. Furthermore, there is a growing need for thin batteries to be installed in various wearable devices and medical patches, leading to diversified requirements for solid state secondary batteries.

### SUMMARY

According to embodiments of the present disclosure, a laminate for a solid state electrochemical element is provided which includes a sulfide solid electrolyte-containing layer and an insulating resin layer at least partially in contact with the sulfide solid electrolyte-containing layer, wherein the insulating resin layer has a porous structure and includes a structural unit represented by the following Chemical Formula 1 or Chemical Formula 2,

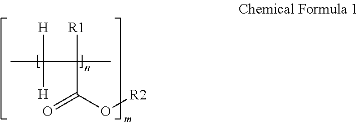

where R1 represents a hydrogen atom or a methyl group and R2 represents a polyester chain or an acrylic oligomer ester derivative,

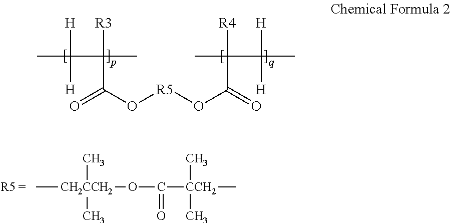

where R3 and R4 each, independently, represent hydrogen atoms or methyl groups.

As another aspect of embodiments of the present disclosure, a solid state electrochemical element is provided which includes the laminate mentioned above.

As another aspect of embodiments of the present disclosure, an electric device is provided which includes the solid state electrochemical element mentioned above.

As another aspect of embodiments of the present disclosure, a mobile object is provided which includes the solid state electrochemical element mentioned above.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating a cross-sectional view of a device for manufacturing an electrode for electrochemical element according to the present disclosure;

FIG. 2A is a schematic diagram illustrating a cross sectional view of an electrode laminate according to the present disclosure;

FIG. 2B is a schematic diagram illustrating a cross sectional view of an electrode laminate according to the present disclosure;

FIG. 2C is a schematic diagram illustrating a cross sectional view of an electrode laminate according to the present disclosure;

FIG. 3 is a schematic diagram illustrating a top view of a device for manufacturing an electrode for electrochemical element according to the present disclosure;

FIG. 4 is a schematic diagram illustrating a top view of a device for manufacturing an electrode for electrochemical element according to the present disclosure;

FIG. 5 is a schematic diagram illustrating a top view of a device for manufacturing an electrode for electrochemical element according to the present disclosure;

FIG. 6A is a schematic diagram illustrating a cross sectional view (part 1) of a positional relationship between the insulating resin layer and electrode composite layer in an electrode for electrochemical element according to the present disclosure;

FIG. 6B is a schematic diagram illustrating a cross sectional view (part 2) of a positional relationship between the insulating resin layer and electrode composite layer in an electrode for electrochemical element according to the present disclosure;

FIG. 6C is a schematic diagram illustrating a cross sectional view (part 3) of a positional relationship between the insulating resin layer and electrode composite layer in an electrode for electrochemical element according to the present disclosure;

FIG. 6D is a schematic diagram illustrating a cross sectional view (part 4) of a positional relationship between the insulating resin layer and electrode composite layer in an electrode for electrochemical element according to the present disclosure;

FIG. 7 is a schematic diagram illustrating a top view of a positional relationship between the insulating resin layer and electrode composite layer in an electrode for electrochemical element according to the present disclosure;

FIG. 8A is a schematic diagram illustrating a cross sectional view (part 1) of a relationship of the average thickness between the insulating resin layer and electrode composite layer in an electrode for electrochemical element according to the present disclosure;

FIG. 8B is a schematic diagram illustrating a cross sectional view (part 2) of a relationship of the average thickness between the insulating resin layer and electrode composite layer in an electrode for electrochemical element according to the present disclosure;

FIG. 8C is a schematic diagram illustrating a cross sectional view (part 3) of a relationship of the average thickness between the insulating resin layer and electrode composite layer in an electrode for electrochemical element according to the present disclosure;

FIG. 9 is a schematic diagram illustrating an example of a device (liquid discharging device) for manufacturing an insulating resin layer to execute the method of manufacturing the electrode laminate according to the present disclosure;

FIG. 10 is a schematic diagram illustrating an example of a device (liquid discharging device) for manufacturing an insulating resin layer to execute the method of manufacturing the electrode laminate according to the present disclosure;

FIG. 11 is a schematic diagram illustrating a method of manufacturing an electrode for electrochemical element according to the present disclosure;

FIG. 12 is a schematic diagram illustrating an example of a device (liquid discharging device) for manufacturing an insulating resin layer to execute the method of manufacturing the electrode laminate according to the present disclosure;

FIG. 13 is a diagram illustrating a configuration of an example of the printing unit employing an inkjet method and transfer method as the liquid composition applying device in a device for manufacturing insulating resin layers according to the present disclosure;

FIG. 14 is a diagram illustrating a configuration of an example of the printing unit employing an inkjet method and transfer method as the liquid composition applying device in a device for manufacturing insulating resin layers according to the present disclosure;

FIG. 15 is a schematic diagram illustrating an electrochemical element according to the present disclosure;

FIG. 16 is a schematic diagram illustrating a solid state battery, which is an electrochemical element according to the present disclosure; and

FIG. 17 is a schematic diagram illustrating a mobile object, which is an electrochemical element according to the present disclosure.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant

According to the present disclosure, a laminate for a solid state electrochemical element is provided which exhibits excellent curl development reduction during film formation and superior degradation reduction of the sulfide solid electrolyte-containing layer.

Typically, to improve the performance of solid state batteries, such as achieving a highly dense battery, a laminate including a positive electrode, a solid electrolyte layer, and a negative electrode is sometimes pressed under extremely high pressure during production. Such high pressure raises concerns about damage, including cracks in the solid electrolyte layer or misalignment of the edges, which could lead to short circuits between the positive electrodes and the negative electrode during battery use.

As for solid state secondary batteries, for example, in an attempt to provide a solid state battery that can minimize cracks occurring during lamination pressing in the manufacturing process and prevent short circuits caused by tab contact, a positive electrode for a solid state electrochemical element has been proposed in WO 2020-022111 A1. This positive electrode includes a positive current collector and a positive active material layer, which contains a positive active material formed on the positive current collector, with a guide for the active material layer positioned on two sides of the outer perimeter of the positive active material layer.

In an attempt to prevent such damage in solid state batteries, WO 2020-022111 A1 mentioned above proposes a positive electrode for a solid state electrochemical element with an active material layer guide. This guide is designed to prevent short circuits, so it must have insulating properties and a thickness similar to that of the electrode composite layer. Additionally, because the active material layer guide needs to withstand high-pressure pressing, it is preferred to be made of a resin-based material that has a certain degree of viscoelasticity.

If the active material layer guide is formed by coating and curing a liquid composition in which resin is dissolved, the resulting film needs to be thicker than the desired guide. Since this coating raises concerns about dripping at the edges, a photocurable liquid composition is commonly used to produce the active material layer guide.

Photocurable liquid compositions often contain a photopolymerization initiator and an acrylic polyfunctional polymerizable compound. In the case of photocuring with such a photocurable liquid composition containing a polyfunctional polymerizable compound, a large number of polymerizable compounds polymerize into a single molecule, leading to volume shrinkage due to the gap between the van der Waals distance and the covalent bond distance. Also, if curing is performed in the presence of a diluting solvent, the polymerization occurs in a significantly swollen state due to the impregnation of the diluting solvent, resulting in volume shrinkage during the solvent removal process. These volume shrinkages raise concerns about the delamination of the active material layer guide from the substrate, the occurrence of curling (warping) of the substrate, and, as a result, the damage to the adjacent electrode composite layer.

Through diligent research, the inventors of the present disclosure discovered that if a porous membrane is formed under the control of the solubility balance between a difunctional or trifunctional acrylate with a flexible polyalkylene oxide structure and a solvent, volume shrinkage is reduced (refer to Japanese patent application No. 2023-009731).

There are concerns, however, that the resin layer composed of polyethylene glycol diacrylate, a representative example of alkylene oxide-based acrylates, could degrade the sulfide solid electrolyte layer, which is commonly used as a solid electrolyte, indicating room for improvement.

The laminate for solid state electrochemical elements of the present disclosure includes a sulfide solid electrolyte-containing layer and an insulating resin layer disposed to be in contact with at least a portion of the sulfide solid electrolyte-containing layer.

The insulating resin layer has specific structural units and a porous structure. This configuration can sufficiently resolve various concerns found in typical technologies. More specifically, it realizes a laminate for solid state electrochemical elements that exhibits excellent curl development reduction during film formation and a superior degradation reduction effect on the sulfide solid electrolyte-containing layer.

The present disclosure is described in detail below.

### Laminate for Solid State Electrochemical Element

The laminate solid state electrochemical elements according to the present disclosure includes a sulfide solid electrolyte-containing layer and an insulating resin layer arranged to be in contact with at least a part of the sulfide solid electrolyte-containing layer, and may optionally include a substrate or other members.

The solid state electrochemical elements described in the present specification are not particularly limited and can be appropriately selected according to the purpose. Examples include, but are not limited to, solid state batteries and solid state capacitors.

In the laminate for a solid state electrochemical element according to the present disclosure, the insulating resin layer is arranged to be in contact with at least a part of the sulfide solid electrolyte-containing layer. The term “contact” means that the sulfide solid electrolyte-containing layer and the insulating resin layer are physically touching.

The positional relationship between the sulfide solid electrolyte-containing layer and the insulating resin layer is not particularly limited as long as they are in contact when the substrate of the laminate for solid state electrochemical elements is taken as the reference plane. For example, the insulating resin layer may be in contact with the periphery of a sulfide solid electrolyte-containing layer (e.g., an electrode composite layer) formed on the substrate, or the sulfide solid electrolyte-containing layer may be laminated on top of the insulating resin layer formed on the substrate.

### Substrate

The substrate in the present disclosure is not particularly limited as long as it has electronic conductivity and is stable with respect to the applied potential. It can be appropriately selected according to the purpose. Examples include, but are not limited to, aluminum foil, copper foil, stainless steel foil, titanium foil, etched foil with fine holes created by etching such foil, carbon-coated foil with a surface layer coated with a carbon-containing resin layer, and perforated substrates used in lithium-ion capacitors.

### Sulfide Solid Electrolyte-Containing Layer

The sulfide solid electrolyte in the sulfide solid electrolyte-containing layer in the present disclosure is not particularly limited as long as it is a solid substance that has electronic insulating properties and exhibits ionic conductivity. Examples include, but are not limited to, Li₁₀GeP₂S₁₂ and Li₆PS₅X (X=F, Cl, Br, I) with an argyrodite-type crystal structure. These can be used alone or in combination.

### Insulating Resin Layer

The insulating resin layer described in the present specification contains a structural unit represented by Chemical Formula 1 or Chemical Formula 2 and has a porous structure.

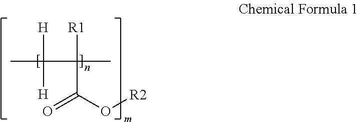

In Chemical Formula 1, R1 represents a hydrogen atom or a methyl group and R2 represents a polyester chain or an acrylic oligomer ester derivative.

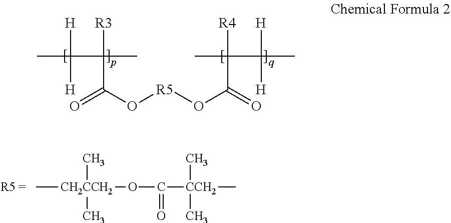

In Chemical Formula 2, R3 and R4 each, independently, represents a hydrogen atom or a methyl group.

In Chemical Formula 2, R5 represents a structure derived from hydroxypivalic acid neopentyl glycol.

The insulating resin layer in the present disclosure includes a structural unit represented by Chemical Formula 1 or Chemical Formula 2, thus minimizing the degradation of the sulfide solid electrolyte-containing layer disposed in contact with the insulating resin layer.

It is preferable that R1 in the structural unit represented by Chemical Formula 1, and R3 and R4 in the structural unit represented by Chemical Formula 2 be hydrogen atoms to lower the glass transition temperature, improve flexibility, and minimize curling.

To further reduce the degradation of the sulfide solid electrolyte-containing layer, it is preferable that the insulating resin layer in the present disclosure includes structural units where R2 in Chemical Formula 1 is a polyester chain, or structural units represented by Chemical Formula 2. More preferably, R2 in Chemical Formula 1 is a polyester chain, and even more preferably, a polycaprolactone chain.

As for the value of n in the structural units represented by Chemical Formula 1, there are no particular restrictions, and it can be appropriately selected as long as the effects of the present disclosure are not impaired. Examples include, but are not limited to, integers from 2 to 1000.

As for the value of m in the structural units represented by Chemical Formula 1, there are no particular restrictions, and it can be appropriately selected as long as the effects of the present disclosure are not impaired. Examples include, but are not limited to, integers from 1 to 4.

As for the values of p and q in the structural units represented by Chemical Formula 2, there are no particular restrictions, and it can be appropriately selected as long as the effects of the present disclosure are not impaired. Examples include, but are not limited to, integers from 2 to 1000.

It is sufficient if the non-crosslinked resin includes at least one type of the structural unit represented by Chemical Formula 1 or Chemical Formula 2. In other words, the insulating resin layer may contain only a structural unit represented by Chemical Formula 1 or Chemical Formula 2, or may contain two or more different structural units represented by Chemical Formula 1 or Chemical Formula 2. In either case, in addition to the structural unit represented by Chemical Formula 1 or Chemical Formula 2, structural units that do not meet Chemical Formula 1 or Chemical Formula 2 may also be contained.

To minimize the degradation of the sulfide solid electrolyte-containing layer, it is preferable that the insulating resin layer in the present disclosure be free of structural units that do not meet Chemical Formula 1 or Chemical Formula 2. Furthermore, the polymerizable compound in the present disclosure preferably contains two or more different structural units represented by Chemical Formula 1 or Chemical Formula 2 to expand the controllable range of the physical properties (for example, elastic modulus) of the insulating resin layer.

Such an insulating resin layer with a porous structure is unlikely to experience residual stress due to volume shrinkage, which helps to minimize curling. This structure is particularly effective for forming an insulating resin layer with an average thickness of at least 100 μm.

The porous structure is preferably a co-continuous structure with a framework formed of a resin.

The term “co-continuous structure” refers to a structure in which two or more materials or phases each have a continuous structure and do not form an interface. In the present embodiment, it refers to a structure where both the resin phase and the void phase are three-dimensional, branched, networked continuous phases.

These structures can be formed through polymerization-induced phase separation (for example, see Japanese Unexamined Patent Application Publication No. 2003-1911628, WO 97/044363 A1, Japanese Unexamined Patent Application Publication No. 2005-298757, Japanese Examined Patent Application Publication No. 2010-513589, Japanese Unexamined Patent Application Publication No. 2001-163907, and Japanese Unexamined Patent Application Publication No. 2001-138504).

The term “polymerization-induced phase separation” refers to the state in which, before polymerization begins, the polymerizable compound and the solvent are mutually soluble, but after the polymerization starts, the resulting polymer (resin) and the solvent become insoluble, leading to phase separation. Although there are other methods of obtaining a porous structure through phase separation, the co-continuous porous structure obtained through polymerization-induced phase separation has the advantage of high resistance to chemicals and heat. Additionally, compared to other methods, it offers the benefits of a shorter process time and easier surface modification.

Next, the process for forming a porous structure using polymerization-induced phase separation with a liquid composition containing a polymerizable compound will be explained. The polymerizable compound undergoes a polymerization reaction upon exposure to light or other stimuli to form a resin. During this process, solubility of the growing resin in the solvent decreases. As a consequence, phase separation occurs between the resin and the solvent. Eventually, the resin forms a co-continuous porous structure where the solvent or other materials fill the pores, with the resin forming the skeletal framework. Upon drying, the solvent is removed, leaving behind a porous resin with a three-dimensional networked co-continuous structure.

Considering this polymerization-induced phase separation, the liquid composition containing a polymerizable compound, as a preferred form of ink, contains a mixture of a polymerizable compound (monomer) and a solvent, where the resin formed after polymerization is insoluble in the solvent or does not form a gel or sol.

To confirm that the insulating resin layer has a co-continuous structure with continuous pores, for example, scanning electron microscopy (SEM) can be used to observe the cross-section of the insulating resin layer and verify the continuity of the connections between the pores.

### Example of Image Observation Method Using Scanning Electron Microscopy (SEM)

First, the insulating resin layer is osmium stained and then subjected to vacuum impregnation with epoxy resin. The internal cross-section structure is then cut out using a focused ion beam (FIB) and observed using a scanning electron microscope (SEM).

There are no particular restrictions on the porosity of the insulating resin layer, and it can be appropriately selected according to the purpose, A porosity of at least 30 percent is preferred, and at least 50 percent is even more preferable. Additionally, a porosity of at most 90 percent is preferred, and at most 85 percent is even more preferable.

A porosity of at least 30 percent in the insulating resin layer is preferred, as it helps to alleviate the pressure on the sulfide solid electrolyte-containing layer from the insulating resin layer during the pressing process after the formation of the sulfide solid electrolyte-containing layer.

A porosity of at most 90 percent is desirable for the insulating resin layer to enhance its strength, ensuring adequate shape retention after the pressing process.

The porosity of the insulating resin layer can be measured using the method described in the section “Example of Image Observation Method Using Scanning Electron Microscopy (SEM).”

The air permeability of the insulating resin layer is not particularly limited and can be appropriately selected according to the purpose. Preferably, it is not more than 1,000 seconds/100 mL, more preferably not more than 500 seconds/100 mL, and even more preferably not more than 300 seconds/100 mL.

Air permeability is measured in accordance with JIS P8117 (Paper and board-Determination of air permeance and air resistance (medium range)-Gurley method) and can be measured using, for example, a Gurley densometer (available from Toyo Seiki Seisaku-Sho, Ltd.). As one example, it may be determined that the pores are interconnected or continuous if the air permeability is not more than 1,000 seconds/100 mLs.

The cross-sectional shape of the pores in the insulating resin layer is not particularly limited and can be appropriately selected according to the purpose. Examples include, but are not limited to, substantially circular, elliptical, or polygonal shapes. The size of the pores refers to the length of the longest part of the cross-sectional shape in the insulating resin layer. The size of the pores in the insulating resin layer can be determined, for example, from cross-section images taken using a scanning electron microscope (SEM).

The size of the pores in the insulating resin layer is not particularly limited and can be appropriately selected according to the purpose. Preferably, the ratio of the pore size to the median diameter of the sulfide electrolyte contained in the liquid composition for forming the sulfide solid electrolyte-containing layer (i.e., liquid composition for sulfide solid electrolyte-containing layer) applied on the insulating resin layer is less than 1, and more preferably 0.8 or less.

If the pore size in the insulating resin layer is larger than the median diameter of the sulfide solid electrolyte, the sulfide solid electrolyte is more likely to be trapped in the pores of the insulating resin layer. An insulating resin layer with a pore size smaller than the median diameter of the sulfide solid electrolyte can form a structure that minimizes the inclusion of the sulfide solid electrolyte within the insulating resin layer. This structure is advantageous for pressure distribution during pressing and for alleviating the pressure exerted by the insulating resin layer on the sulfide solid electrolyte-containing layer.

There are no particular limitations on the methods of controlling the pore size and porosity of the insulating resin layer, and they can be appropriately selected according to the purpose. Examples include, but are not limited to, adjusting the content of the polymerizable compound in the liquid composition, adjusting the content of the solvent in the liquid composition, and adjusting the irradiation conditions of the actinic ray.

There are no particular limitations on the volume resistivity of the insulating resin layer in the present disclosure, and it can be appropriately selected according to the purpose. It is preferable for the volume resistivity to be at least 10¹² Ω·cm. Additionally, it is preferable for the resin layer to be free of conductive paths even if conductive fillers or similar additives are added.

### Liquid Composition

In the present disclosure, it is preferable that the insulating resin layer be a cured product of a liquid composition (cured liquid composition) containing a polymerizable compound represented by Chemical Formula 3 or Chemical Formula 4 and a solvent, to more effectively prevent curling.

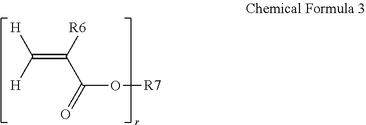

In Chemical Formula 3, R6 represents a hydrogen atom or a methyl group and R7 represents a polyester chain or an acrylic oligomer ester derivative.

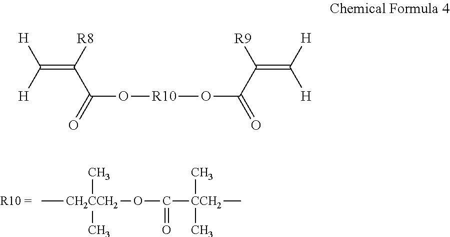

In Chemical Formula 4, R8 and R9 each, independently, represent hydrogen atoms or methyl groups.

### Polymerizable Compound

The polymerizable compound in the present specification is represented by Chemical Formula 3 or Chemical Formula 4.

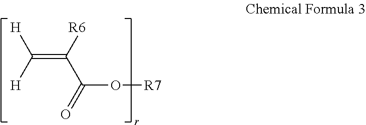

In Chemical Formula 3, R6 represents a hydrogen atom or a methyl group and R7 represents a polyester chain or an acrylic oligomer ester derivative.

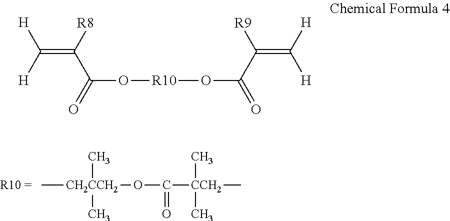

In Chemical Formula 4, R8 and R9 each, independently, represent hydrogen atoms or methyl groups.

In Chemical Formula 4, R10 represents a structure derived from hydroxypivalic acid neopentyl glycol.

r in Chemical Formula 3 is preferably 2 or 3, and more preferably 2 to reduce curling of the insulating resin layer.

The term “polymerizable compound” in the present specification refers to a compound having multiple vinyl groups that can undergo radical polymerization, and it is preferable that the compound have an acrylic group to achieve high-speed polymerization using electron beams. That is, it is preferable that R6 in Chemical Formula 3, and R8 and R9 in Chemical Formula 4, be hydrogen atoms.

Generally, acrylic groups have high radical polymerizability, allowing for the rapid formation of a cured product when used in combination with a photopolymerization initiator or a thermal polymerization initiator. Cured products can be obtained without the use of polymerization initiators. However, in the case of a polymerizable compound with an acrylic group (i.e., R6 in Chemical Formula 3 and R8 and R9 in Chemical Formula 4), it is preferable from the perspective of polymerization rate and equipment cost to use the polymerizable compound in combination with a thermal polymerization initiator or a photopolymerization initiator, and it is even more preferable to use the polymerizable compound in combination with a photopolymerization initiator.

To further reduce the degradation of the sulfide solid electrolyte-containing layer, it is preferable that the liquid composition in the present disclosure contain a polymerizable compound where R7 in Chemical Formula 3 is a polyester chain or a polymerizable compound represented by Chemical Formula 4. It is more preferable that the liquid composition contain a polymerizable compound where R7 in Chemical Formula 3 is a polyester chain, and even more preferable that it contains a polymerizable compound where R7 in Chemical Formula 3 is a polycaprolactone chain.

As examples of the polymerizable compounds represented by Chemical Formula 3 or Chemical Formula 4, there are, for instance, hydroxypivalic acid neopentyl glycol acrylate adducts, difunctional acrylate oligomer esters, difunctional caprolactam-modified acrylates, and polyester acrylates.

Specific examples of the hydroxy pivalic acid neopentyl glycol acrylate adducts include, but are not limited to, those sold under the trade names Light Acrylate HPP-A (available from Kyoeisha Chemical Co., Ltd.), VISCOAT® #195, VISCOAT® #230, and VISCOAT® #260 (all available from OSAKA ORGANIC CHEMICAL INDUSTRY LTD.), Miramer M210 and Miramer M216 (both available from Miwon Specialty Chemical Co., Ltd.), and KAYARAD FM-400 (available from Nippon Kayaku Co., Ltd.).

A specific example of the difunctional acrylic acid polymer ester acrylate is VISCOAT® #230D (available from Osaka Organic Chemical Industry Ltd.).

Specific examples of the difunctional caprolactam-modified acrylates include, but are not limited to, those sold under the trade names KAYARAD HX-220 and KAYARAD HX-620 (both available from Nippon Kayaku Co., Ltd.).

Specific examples of polyester acrylates include, but are not limited to, commercial products such as CN2273 (available from TOMOE Engineering Co., Ltd.) and CN2283 (available from TOMOE Engineering Co., Ltd.).

As for the polymerizable compounds in the present disclosure, it is sufficient if at least one polymerizable compound represented by Chemical Formula 3 or Chemical Formula 4 is included. In other words, the polymerizable compounds in the present disclosure may contain only a polymerizable compound represented by Chemical Formula 3 or Chemical Formula 4, or may contain two or more different polymerizable compounds represented by Chemical Formula 3 or Chemical Formula 4. In either case, in addition to the polymerizable compounds represented by Chemical Formula 3 or Chemical Formula 4, polymerizable compounds that do not meet Chemical Formula 3 or Chemical Formula 4 may also be contained.

To minimize the degradation of the sulfide solid electrolyte-containing layer, it is preferable that the polymerizable compounds in the present disclosure be free of polymerizable compounds that do not meet Chemical Formula 3 or Chemical Formula 4. Furthermore, the polymerizable compound in the present disclosure preferably contains two or more different polymerizable compounds represented by Chemical Formula 3 or Chemical Formula 4 to expand the controllable range of the physical properties (for example, elastic modulus) of the insulating resin layer.

There are no particular limitations on the photopolymerization initiator, and it can be selected as appropriate according to the purpose. Examples include, but are not limited to, alkylphenone-based polymerization initiators, acylphosphine sulfite-based polymerization initiators, and oxime ester-based polymerization initiators.

Specific examples of alkylphenone-based polymerization initiators include, but are not limited to, Omnirad 651 (available from IGM Resins B.V.), Omnirad 184 (available from IGM Resins B.V.), Omnirad 1173 (available from IGM Resins B.V.), Omnirad 2959 (available from IGM Resins B.V.), Omnirad 127 (available from IGM Resins B.V.), Omnirad 907 (available from IGM Resins B.V.), Omnirad 369 (available from IGM Resins B.V.), Omnirad 369E (available from IGM Resins B.V.), and Omnirad 379EG (available from IGM Resins B.V.).

Specific examples of acylphosphine sulfite-based polymerization initiators include, but are not limited to, Omnirad TPO (available from IGM Resins B.V.) and Omnirad 819 (available from IGM Resins B.V.).

Specific examples of oxime ester-based polymerization initiators include, but are not limited to, Irgacure OXE01 (available from BASF Japan), Irgacure OXE02 (available from BASF Japan), Irgacure OXE03 (available from BASF Japan), and Irgacure OXE04 (available from BASF Japan).

The proportion of the polymerization initiator is not particularly limited and can be suitably selected to suit to a particular application. The content is preferably 0.05 to 10.0 percent by mass, and more preferably 0.1 to 5.0 percent by mass, of the total polymerizable compound to achieve a sufficient curing rate.

### Solvent

To form the insulating resin layer in the present disclosure through polymerization-induced phase separation, adding a solvent to the polymerizable compound is preferable to minimize volume shrinkage during polymerization.

The solvent in the liquid composition is expected to act as a buffer for curing shrinkage, as there is no fluctuation in intermolecular distances between solvent-solvent or resin-solvent during polymerization.

In the present specification, the term “solvent” refers to an organic solvent with a water content at most 1 percent by mass, and is preferably a low-polarity, hydrophobic solvent that exhibits low reactivity with the sulfide solid electrolyte-containing layer.

Specific examples of the solvent include, but are not limited to, aromatic hydrocarbons such as toluene, xylene, mesitylene, anisole, and phenetole; hydrocarbon solvents such as hexane, heptane, nonane, octane, decane, menthane, cyclohexane, cyclooctane, and p-menthane; ester solvents such as ethyl butyrate, ethyl valerate, ethyl caproate, ethyl heptanoate, ethyl octanoate, ethyl nonanoate, ethyl decanoate, ethyl undecanoate, ethyl laurate, methyl butyrate, methyl valerate, methyl caproate, methyl heptanoate, methyl octanoate, methyl nonanoate, methyl decanoate, methyl undecanoate, methyl laurate, ethyl isovalerate, isoamyl acetate, isobutyl isobutyrate, 3-methoxyisobutyric acid methyl ester, butyl isobutyrate, isobutyl isovalerate, 2-methylbutyl isobutyrate, butyl isovalerate, heptyl acetate, isoamyl isovalerate, 2-ethylhexyl acetate, hexyl butyrate, ethyl benzoate, hexyl caproate, n-amyl octanoate, and hexyl acetate; and petroleum-based solvent mixtures.

Specific examples of the petroleum-based solvent mixtures include, but are not limited to, products sold under the trade names ISOPAR E, ISOPAR G, ISOPAR H, ISOPAR H BHT, ISOPAR L, ISOPAR M, EXXSOL D40, EXXSOL D80, EXXSOL D110, EXXSOL D130, EXXSOL DSP 80/100, and EXXSOL DSP 145/60 (all available from ANDOH PARACHEMIE CO., LTD.).

The content of the solvent is not particularly restricted and can be appropriately selected according to the purpose. From the viewpoint of curl development reduction, the solvent is at least 30 percent by mass of the total amount of the liquid composition, more preferably at least 40 percent by mass, and even more preferably at least 50 percent by mass. Additionally, the solvent content is preferably at most 70 percent by mass to control the film thickness.

The solvent in the present disclosure may be a combination of multiple solvents to increase the diversity of polymerizable compound selection.

### First Aspect of Liquid Composition

As a first aspect of the first liquid composition in the present disclosure, the solvent in the liquid composition is a solvent mixture containing both good and poor solvents to minimize curling development due to volume shrinkage, and satisfies the following Relationship 1.

Polymerizable compound soluble point≤Mixing ratio X<Polymerizable compound soluble point+11 Relationship 1

In the present specification, “good solvent” refers to a solvent in which the polymerizable compound is soluble. In the present specification, “poor solvent” refers to a solvent which leaves the polymerizable compound undissolved. Furthermore, in the present specification, “solvent mixture” refers to a solvent that contains both good and poor solvents.

In this specification, “mixing ratio X” refers to the percentage-based content ratio of the good solvent in a solvent mixture by mass in the solvent mixture.

In this specification, “polymerizable compound soluble point” refers to the minimum content ratio by mass of the good solvent in a solvent mixture in which the polymerizable compound is soluble, expressed as a percentage.

The term “soluble” in the first aspect is explained below. “Soluble” refers to the property where, after mixing the solvent and the polymerizable compound followed by ultrasonic stirring for 15 minutes with an ultrasonic stirrer (USS-1), no turbidity or phase separation occurs after standing for 10 minutes at a specified temperature. The specified temperature is not particularly limited as long as it is the ambient temperature during actual use. For example, it includes 25 degrees Celsius.

The determination of solubility or insolubility is made according to the composition of the liquid composition in the first aspect. For example, the following patterns 1 to 2 can be considered.

### Pattern 1

In the case of a liquid composition containing one polymerizable compound represented by Chemical Formula 3 or Chemical Formula 4 and two solvents (solvent mixture), the solubility or insolubility is determined based on the solvent ratio (mass ratio) in a liquid composition that contains 10 g of the solvent mixture and 1 g of the polymerizable compound represented by Chemical Formula 3 or Chemical Formula 4.

### Pattern 2

In the case of a liquid composition containing two polymerizable compounds (compound mixture) represented by Chemical Formula 3 or Chemical Formula 4 and two solvents (solvent mixture), the solubility or insolubility is determined based on the solvent ratio (mass ratio) in a liquid composition that contains 10 g of the solvent mixture and 1 g of the compound mixture of compounds.

Relationship 1 can also be transformed into Relationship 1′.

0≤Mixing ratio X−Polymerizable compound soluble point≤11 Relationship 1′

The liquid composition can form a resin layer with high porosity based on the phase separation rate under Relationship 1 or Relationship 1′. As a result, it is possible to minimize volume shrinkage occurring during the curing of the liquid composition, thereby achieving a high-quality resin layer.

Furthermore, as the “mixing ratio X−polymerizable compound solubility point” in Relationship 1′ approaches zero, the curling caused by volume shrinkage can be further reduced.

### Second Aspect of Liquid Composition

As a second aspect of the liquid composition in the present disclosure, the polymerizable compound in the liquid composition is a compound mixture containing both a soluble polymerizable compound and an insoluble polymerizable compound to reduce curling due to volume shrinkage, and satisfies the following Relationship 2.

Solvent soluble point≤Mixing ratio Y<Solvent soluble point+21 Relationship 2

In the present specification, the term “soluble polymerizable compound” refers to a polymerizable compound that is soluble in a solvent. The term “insoluble polymerizable compound” refers to a polymerizable compound that is insoluble in a solvent. Additionally, when the term “compound mixture” is used in the present specification, it refers to a polymerizable compound that contains both soluble and insoluble polymerizable compounds.

The term “mixing ratio Y” refers to the percentage of the mass-based content of the insoluble polymerizable compounds within the compound mixture.

The term “solvent soluble point” refers to the minimum content ratio (percentage) based on the mass of the insoluble polymerizable compounds in the compound mixture that is soluble to the solvent.

The term “soluble” in the second aspect is explained below. The term “soluble” refers to the property where, after mixing the solvent and the polymerizable compound followed by ultrasonic stirring for 15 minutes with an ultrasonic stirrer (USS-1), no turbidity or phase separation occurs after standing for 10 minutes at a specified temperature. The specified temperature is not particularly limited as long as it is the ambient temperature during actual use. For example, it includes 25 degrees Celsius.

The determination of solubility or insolubility is made according to the composition of the liquid composition in the second aspect. For example, the following patterns 3 to 4 can be considered.

### Pattern 3

In the case of a liquid composition containing two polymerizable compounds (compound mixture) represented by Chemical Formula 3 or Chemical Formula 4 and two solvents (solvent mixture), the solubility or insolubility is determined based on the solvent ratio (mass ratio) in a liquid composition that contains 10 g of the compound mixture and 1 g of the solvent mixture of compounds.

### Pattern 4

In the case of a liquid composition containing two polymerizable compounds (compound mixture) represented by Chemical Formula 3 or Chemical Formula 4 and one solvent, the solubility or insolubility is determined based on the monomer ratio (mass ratio) in a liquid composition that contains 10 g of the compound mixture and 1 g of the solvent.

Relationship 2 can also be transformed into Relationship 2′.

0≤Mixing ratio Y−Solvent soluble point≤21 Relationship 2′

The liquid composition can form a resin layer with high porosity based on the phase separation rate under Relationship 2 or Relationship 2′. As a result, it is possible to minimize volume shrinkage occurring during the curing of the liquid composition, thereby achieving a high-quality resin layer.

Furthermore, as the “Mixing ratio Y−Solvent soluble point” in Relationship 2′ approaches zero, the curling due to volume shrinkage can be further reduced.

There are no particular limitations on the method of producing the liquid composition, and it can be appropriately selected depending on the purpose. For example, the liquid composition can be produced through processes such as mixing polymerizable compounds, mixing polymerizable compounds with a solvent, dissolving a polymerization initiator in the solvent, dissolving an insulating resin in a liquid composition, and stirring.

### Method of Manufacturing Laminate for Solid State Electrochemical Element and Apparatus for Manufacturing Laminate for Solid State Electrochemical Element

The method of manufacturing a laminate for a solid state electrochemical element relating to the present disclosure includes forming an insulating resin layer, forming a sulfide solid electrolyte-containing layer, and other optional processes.

The apparatus for manufacturing a laminate for a solid state electrochemical element of the present disclosure includes a storage container, a device for forming an insulating resin layer, a device for forming a sulfide solid electrolyte-containing layer, and other optional devices.

### Storage Container

The storage container includes a liquid composition and a vessel accommodating the liquid composition.

Specific examples of the vessel include, but are not limited to, a glass bottle, a plastic vessel, a plastic bottle, a stainless steel bottle, a 18-liter drum, and a drum.

Note that the liquid composition is the same as described in the section on Laminate for Solid State Electrochemical Element, so redundant descriptions are omitted.

### Process of Forming Insulating Resin Layer and Device for Forming Insulating Resin Layer

The process of forming an insulating resin layer is to form an insulating resin layer on a substrate. The process of forming an insulating resin layer preferably includes a liquid composition applying process and a liquid composition curing process.

The device for forming an insulating resin layer is to form an insulating resin layer on a substrate. The device for forming an insulating resin layer preferably includes a liquid composition applying device and a liquid composition curing device.

The process of forming an insulating resin layer can be suitably carried out by the device for forming an insulating resin layer, the liquid composition applying process can be suitably carried out by the liquid composition applying device, and the liquid composition curing process can be suitably carried out by the liquid composition curing device.

### Process of Applying Liquid Composition and Device for Applying Liquid Composition

In the liquid composition application, a liquid composition is applied to a substrate.

The device for applying a liquid composition applies a liquid composition to a substrate.

The process of applying a liquid composition and the device for applying a liquid composition are not particularly limited and can be suitably selected to suit to a particular application. For example, the spin coating method, the casting method, the micro gravure coating method, the gravure coating method, the bar coating method, the roll coating method, the wire bar coating method, the dip coating method, the slit coating method, the capillary coating method, the spray coating method, the nozzle coating method, the gravure printing method, the screen printing method, the flexographic printing method, the offset printing method, the reverse printing method, and the inkjet printing method can be executed by their corresponding printing devices. Of these, inkjet printing is preferable to form an insulating resin layer with precision.

### Process of Curing Liquid Composition and Device for Curing Liquid Composition

The process of curing a liquid composition involves applying heat or light to the liquid composition to cure it.

The device for curing a liquid composition applies heat or light to the liquid composition to cure it.

By applying heat or light to the liquid composition, the polymerizable compound within the liquid composition undergo polymerization and polymerization-inducing phase separation, resulting in an insulating resin layer with a porous structure.

The light used in the process of curing a liquid composition and the device for curing a liquid composition is preferably an actinic ray.

This ray may include any type of actinic radiation that can provide the energy necessary to promote the polymerization reaction of the polymerizable compounds in the liquid composition and is not particularly limited. Examples include, but are not limited to, ultraviolet (UV) rays, electron beams, alpha rays, beta rays, gamma rays, and X-rays. Among these, ultraviolet rays are preferred. Note that in the case of using a particularly high-energy light source, polymerization reactions can be facilitated even without the use of a polymerization initiator.

There are no particular restrictions on the irradiation intensity of the actinic rays, and it can be appropriately selected according to the intended purpose. It is preferably at most 1 W/cm², more preferably at most 300 mW/cm², and even more preferably at most 100 mW/cm².

An excessively low irradiation intensity of the actinic rays can lead to excessive progression of polymerization-induced phase separation, causing variations and coarsening of the porous structure, and longer irradiation times may reduce productivity. Therefore, it is preferably at least 10 mW/cm², and more preferably at least 30 mW/cm².

### Process of Forming Sulfide Solid Electrolyte-Containing Layer and Device for Forming Sulfide Solid Electrolyte-Containing Layer

The process of forming a sulfide solid electrolyte-containing layer in the method of manufacturing a laminate for a solid state electrochemical element involves forming the sulfide solid electrolyte-containing layer such that it contacts at least a portion of the insulating resin layer.

The device for forming the sulfide solid electrolyte-containing layer in the apparatus for manufacturing a laminate for a solid state electrochemical element is to form the sulfide solid electrolyte-containing layer such that it contacts at least a portion of the insulating resin layer.

There are no particular limitations on the process of forming the sulfide solid electrolyte-containing layer, and it can be appropriately selected according to the purpose. For example, the process may involve applying a liquid composition for the sulfide solid electrolyte-containing layer, which contains a sulfide solid electrolyte and optionally a binder, followed by solidification and drying. The method of applying the liquid composition is not particularly limited and it can be suitably selected to suit to a particular application.

Specific examples include, but are not limited to, liquid discharging methods such as an inkjet method, a spray coating method, and a dispenser method, spin coating, casting, MICROGRAVURE™ coating, gravure coating, bar coating, roll coating, wire bar coating, dip coating, slit coating, capillary coating, nozzle coating, gravure printing, screen printing, flexographic printing, offset printing, and reverse printing.

As the binder, polymer compounds can be used. Examples include, but are not limited to, thermoplastic resins such as polyvinylidene fluoride (PVDF), acrylic resin, polyethylene, polypropylene, polyurethane, nylon, polytetrafluoroethylene, polyphenylene sulfide, polyethylene terephthalate, polybutylene terephthalate, polyamide compounds, polyimide compounds, polyamide-imide, ethylene-propylene-butadiene rubber (EPBR), styrene-butadiene rubber (SBR), nitrile butadiene rubber (NBR), isoprene rubber, polyisobutene, polyethylene glycol (PEO), polymethyl methacrylate (PMMA), and polyethylene vinyl acetate (PEVA).

### Other Processes and Other Devices

The other optional process relating to the method of manufacturing a laminate for a solid state electrochemical element is not particularly limited and it can be suitably selected to suit to a particular application unless it has an adverse impact on the effects of the present disclosure. It includes, for example, a process of solvent removing.

The other optional device relating to the device for manufacturing a laminate for a solid state electrochemical element is not particularly limited and it can be suitably selected to suit to a particular application unless it has an adverse impact on the effects of the present disclosure. It includes, for example, a device for removing solvents.

### Solvent Removing Process and Solvent Removing Device

The solvent removing process is to remove the solvent from the insulating resin layer.

The solvent removing device is to remove the solvent from the insulating resin layer. No particular specific restrictions apply to the solvent removal process or the device used for it, and they may be selected as appropriate based on the purpose. One method of removing solvent from the insulating resin layer is heating. In this case, it is preferable to heat under reduced pressure, as this promotes solvent removal and reduces the amount of residual solvent in the insulating resin layer.

Heating can be done using a stage, or a heating mechanism other than a stage may be used. The heating mechanism may be installed on either the upper or lower side of the substrate, or multiple heating mechanisms may be installed. There are no particular restrictions on the heating mechanism; examples include, but are not limited to, resistance heaters, infrared heaters, and fan heaters. There is no particular limit to the heating temperature, but in terms of energy use, it is preferably between 70 degrees Celsius and 150 degrees Celsius.

The laminate for a solid state electrochemical element according to the present disclosure preferably includes a substrate and an electrode active material layer containing an active material as the sulfide solid electrolyte-containing layer. In other words, the laminate for a solid state electrochemical element according to the present disclosure includes a substrate, a sulfide solid electrolyte-containing layer disposed on the substrate, and an insulating resin layer disposed on the outer peripheral portion of the sulfide solid electrolyte-containing layer. The sulfide solid electrolyte-containing layer is an electrode composite layer containing an active material, and the insulating resin layer contains structural units represented by Chemical Formula 1 or Chemical Formula 2 and preferably has a porous structure.

In addition, the laminate for a solid state electrochemical element according to the present disclosure preferably includes a substrate, an electrode composite layer disposed on the substrate, a sulfide solid electrolyte-containing layer disposed on the electrode composite layer, and an insulating resin layer disposed so as to contact at least a portion of the sulfide solid electrolyte-containing layer.

### Electrode for Electrochemical Element

The laminate for a solid state electrochemical element according to the present disclosure can be suitably applied to electrodes for electrochemical elements.

The electrode for an electrochemical element preferably includes a substrate, an electrode composite layer containing a sulfide solid electrolyte disposed on the substrate, and an insulating resin layer disposed on the outer peripheral portion of the electrode composite layer.

The substrate, sulfide solid electrolyte, and insulating resin layer are the same as those described in the section on “Laminate for Solid state Electrochemical Element”, and repeated descriptions are omitted.

In the present specification, the negative electrode and the positive electrode may be referred to as “electrodes,” and the negative electrode substrate and the positive electrode substrate may be referred to as “substrates.” The negative electrode composite layer and the positive electrode composite layer may also be referred to as “electrode composite layers.” In addition, if the first electrode is a negative electrode, the second electrode refers to the positive electrode, and if the first electrode is a positive electrode, the second electrode refers to the negative electrode.

### Electrode Laminate

The electrode for an electrochemical element of the present disclosure can be suitably applied to an electrode laminate.

The electrode laminate preferably includes an electrode for an electrochemical element and a sulfide solid electrolyte-containing layer disposed on the electrode for an electrochemical element. In other words, the electrode laminate preferably includes a substrate, an electrode composite layer containing a sulfide solid electrolyte disposed on the substrate, an insulating resin layer disposed on the outer peripheral portion of the electrode composite layer, and a sulfide solid electrolyte-containing layer disposed on the electrode composite layer and the insulating resin layer.

The substrate, sulfide solid electrolyte, sulfide solid electrolyte-containing layer, and insulating resin layer are the same as those described in the section on “Laminate for Solid state Electrochemical Element”, and repeated descriptions are omitted.

Embodiments of the present disclosure is described with reference to the drawings. The present disclosure is not limited to these embodiments.

In each drawing, the same components may be denoted by the same reference numerals (symbols) and redundant description may be omitted. In addition, the present disclosure is not limited to the number, position, and shapes of the embodiments described above and those can be suitably selected to suit to implementing the present disclosure.

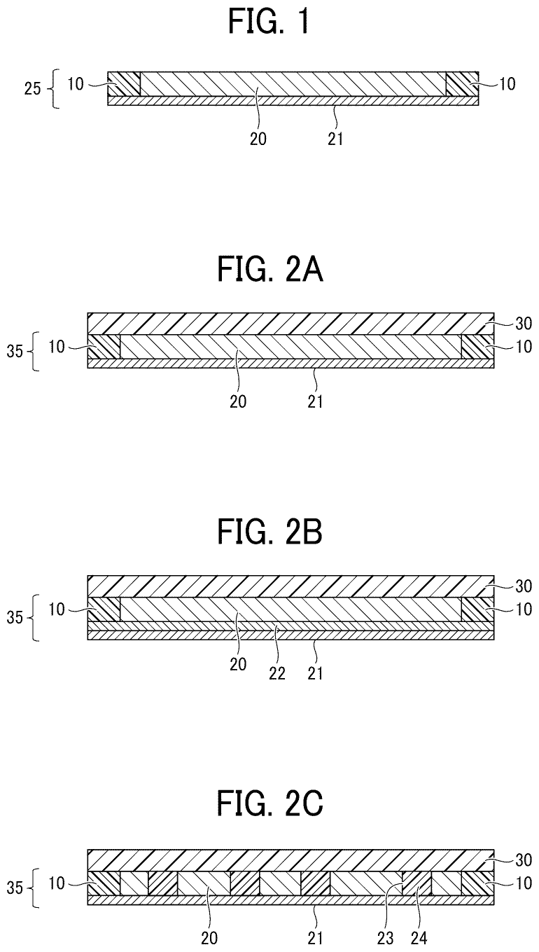

FIG. 1 is a schematic cross-sectional diagram illustrating an electrode for an electrochemical element according to one embodiment of the present disclosure. An electrode 25 for an electrochemical element includes a first substrate 21, a first electrode composite layer 20 disposed on the first substrate 21, and an insulating resin layer 10 disposed on the outer periphery of the first electrode composite layer 20.

Note that FIG. 1 illustrates a configuration in which the first electrode composite layer 20 and the insulating resin layer 10 are provided on one side of the first substrate 21, but the first electrode composite layer 20 and the insulating resin layer 10 may be provided on both opposing sides of the first substrate 21.

FIG. 2A is a schematic diagram illustrating a cross sectional view of an electrode laminate according to a different embodiment of the present disclosure. FIG. 2B is a schematic diagram illustrating a cross sectional view of an electrode laminate according to another embodiment of the present disclosure. FIG. 2C is a schematic diagram illustrating a cross sectional view of an electrode laminate according to yet another embodiment of the present disclosure. An electrode laminate 35 includes a first substrate 21, a first electrode composite layer 20 disposed on the first substrate 21, an insulating resin layer 10 disposed on the outer periphery of the first electrode composite layer 20, and a sulfide solid electrolyte-containing layer 30 disposed on the first electrode composite layer 20 and the insulating resin layer 10.

Note that FIGS. 2A to 2C illustrate the configuration in which the first electrode composite layer 20, the insulating resin layer 10, and the sulfide solid electrolyte-containing layer 30 are provided on one side of the first substrate 21, but the first electrode composite layer 20, the insulating resin layer 10, and the sulfide solid electrolyte-containing layer 30 may be provided on both opposing sides of the first substrate 21.

Furthermore, as illustrated in FIG. 2B, an adhesive layer 22 containing a metal that forms an alloy with lithium may be provided between the substrate 21 and the first electrode composite layer 20.

### Electrode Composite Layer

There are no particular limitations on the electrode composite layer (hereinafter sometimes referred to as an active material layer), and it can be appropriately selected according to the purpose. For example, it may contain an active material (negative electrode active material or positive electrode active material) and a sulfide solid electrolyte, and, if necessary, it may further contain conductive additives, binders, dispersants, and other components.

The electrode composite layer preferably contains an active material and a sulfide solid electrolyte, so that the electrode for the electrochemical element or the electrode laminate has an insulating resin layer that minimizes degradation in ionic conductivity in the sulfide solid electrolyte-containing layer.

The electrode composite layer may have an opening 23 as illustrated in FIG. 2C.

The number of openings 23 is preferably one or more, and more preferably multiple.

The openings 23 may penetrate the electrode composite layer from the surface of the electrode composite layer to the surface of the substrate, or it may not penetrate to the surface of the substrate.

The openings 23 may be hollow or filled with a material 24. When the openings 23 are filled with the material 24, the material 24 may be a single substance or a mixture of two or more substances, but in either case, the material 24 should be different in nature (compound or composition) from the material constituting the electrode composite layer. The material 24 preferably contains the solid electrolyte of the sulfide solid electrolyte-containing layer to improve ion conductivity, and more preferably is a material with the same composition as that of the sulfide solid electrolyte the sulfide solid electrolyte-containing layer contains.

An electrode composite layer with the openings 23 can be suitably manufactured using inkjet as an electrode composite layer forming device because coating control is easy.

### Active Material

The active material can be either a positive electrode active material or a negative electrode active material. The positive electrode active material or negative electrode active material may be used alone or in combination of two or more.

### Positive Electrode Active Material

There is no particular limitation on the positive electrode active material as long as it is a material capable of reversibly absorbing and releasing alkali metal ions. For example, alkali metal-containing transition metal compounds can be used as the positive electrode active materials.

Specific examples of alkali metal-containing transition metal compounds include, but are not limited to, lithium-containing transition metal compounds such as composite oxides containing lithium and one or more elements selected from the group consisting of cobalt, manganese, nickel, chromium, iron, and vanadium.

Specific examples of lithium-containing transition metal compounds include lithium cobalt oxide, lithium nickel oxide, and lithium manganese oxide.

Alkali metal-containing transition metal compounds may also include polyanion compounds having an XO₄ tetrahedron (where X=P, S, As, Mo, W, Si, etc.) in their crystal structure. Of these, lithium-containing transition metal phosphate compounds such as lithium iron phosphate and lithium vanadium phosphate are preferable in terms of cyclability. Lithium vanadium phosphate is preferable in terms of lithium diffusion coefficient and output properties.

As for the polyanion compounds, it is preferable that the surface is coated and compounded with conductive additives such as carbon materials to enhance electronic conductivity.

It is preferable for alkali metal-containing transition metal compounds to be at least partially coated with an ion-conductive oxide on their surface. As the ion-conductive oxide, lithium ion-conductive oxides are preferable.

There are no particular limitations on the selection of lithium ion-conductive oxides, which can be selected according to the purpose.

Specific examples include, but are not limited to, oxides represented by Chemical Formula LiₓAO_{y} (where A represents B, C, Al, Si, P, S, Ti, Zr, Nb, Mo, Ta, Sc, V, Y, Ca, Sr, Ba, Hf, Ta, Cr, or W, and x and y are positive numbers).

Specific examples of lithium ion-conductive oxides include Li₃BO₃, LiBO₂, Li₂CO₃, LiAlO₂, Li₄SiO₄, Li₂SiO₃, Li₃PO₄, Li₂SO₄, Li₂TiO₃, Li₄Ti₅O₁₂, Li₂ Ti₂O₅, Li₂ZrO₃, LiNbO₃, LiTaO₃, Li₂MoO₄, and Li₂WO₄. Among these, Li₄Ti₅O₁₂, Li₂ZrO₃, or LiNbO₃ is preferable.

Lithium ion-conductive oxides may also be composite oxides. Any combination of lithium ion-conductive oxides may be used as composite oxides, such as Li₄SiO₄—Li₃BO₃ and Li₄SiO₄—Li₃PO₄.

### Negative Electrode Active Material

As for the negative electrode active material, there are no particular limitations as long as it is a material capable of reversibly absorbing and releasing alkali metal ions, and it can be appropriately selected according to a particular application. For example, carbon materials containing graphite with a graphite-type crystalline structure can be used.

Examples of carbon materials include, but are not limited to, natural graphite, spherical or fibrous artificial graphite, hard carbon (non-graphitizable carbon), and soft carbon (easily graphitizable carbon).

In addition to carbon materials, examples of other materials include, but are not limited to, lithium titanate and titanium oxide.

High-capacity materials such as silicon, tin, silicon alloys, tin alloys, silicon oxide, silicon nitride, and tin oxide can also be suitably used as negative electrode active materials to increase the energy density of lithium-ion batteries.

### Conductive Assistant

The conductive assistant is not particularly limited and can be suitably selected to suit to a particular application. Examples of the conductive assistant include, but are not limited to, carbon black produced by a method such as a furnace method, an acetylene method, and a gasification method, and carbon materials such as carbon nanofibers, carbon nanotubes, graphene, and graphite particles.

Conductive assistants other than the carbon materials include, but are not limited to, metal particles and metal fiber of aluminum. The conductive assistant may be combined with an active material in advance.

The content of the conductive assistant to an active material is not particularly restricted and can be adjusted according to the purpose. It is preferable for the content to be at most 10 percent by mass, with a more preferable range of at most 8 percent by mass.

A content of the conductive assistant to an active material of at most 10 percent by mass is suitable for enhancing the stability of the liquid composition for an electrode composite layer. A content of the conductive assistant to an active material of at most 8 percent by mass is suitable for further enhancing the stability of the liquid composition for an electrode composite layer.

### Binder

As long as the binder can bind the negative electrode materials to each other, the positive electrode materials to each other, the negative electrode materials to the negative electrode substrate, and the positive electrode materials to the positive electrode substrate, it is not particularly limited and can be appropriately selected according to the purpose. If the liquid composition for forming the electrode composite layer is used for inkjet discharging, it is preferable that the binder minimally increase the viscosity of the liquid composition for forming the electrode composite layer, to minimize nozzle clogging in the liquid discharging head.

As the binder, polymer compounds can be used. Examples include, but are not limited to, thermoplastic resins such as polyvinylidene fluoride (PVDF), acrylic resin, polyethylene, polypropylene, polyurethane, nylon, polytetrafluoroethylene, polyphenylene sulfide, polyethylene terephthalate, polybutylene terephthalate, polyamide compounds, polyimide compounds, polyamide-imide, ethylene-propylene-butadiene rubber (EPBR), styrene-butadiene rubber (SBR), nitrile butadiene rubber (NBR), isoprene rubber, polyisobutene, polyethylene glycol (PEO), polymethyl methacrylate (PMMA), and polyethylene vinyl acetate (PEVA).

The content of the binder to an active material is not particularly restricted and can be appropriately set depending on the purpose. It is preferable that the content be between 1 percent by mass and 15 percent by mass, with a more preferable range between 3 percent by mass and 10 percent by mass. If the content of the binder to an active material is at least 1 percent by mass, it is suitable for strongly binding the active material to the substrate.

### Dispersant

As long as it can improve the dispersibility of the active material within the liquid composition for the electrode composite layer, the dispersant is not particularly restricted.

Examples include, but are not limited to, polymer dispersants such as polyethylene oxide, polypropylene oxide, polycarboxylic acid, naphthalene sulfonic acid formalin condensates, polyethylene glycol, polycarboxylic acid partial alkyl esters, polyether, and polyalkylene polyamine; low molecular weight dispersants such as alkyl sulfonic acid, quaternary ammonium alkylene oxide of higher alcohols, polyvalent alcohol esters, and alkyl polyamines; and inorganic dispersants such as polyphosphate-based dispersants.

### Insulating Resin Layer

The insulating resin layer in the electrode and electrode laminate for the electrochemical element related to the present disclosure is arranged on the outer periphery of the electrode composite layer disposed on the substrate, and may also be arranged on the substrate and on the outer periphery of the substrate.

Embodiments of the present disclosure is described with reference to the drawings. The present disclosure is not limited to these embodiments.

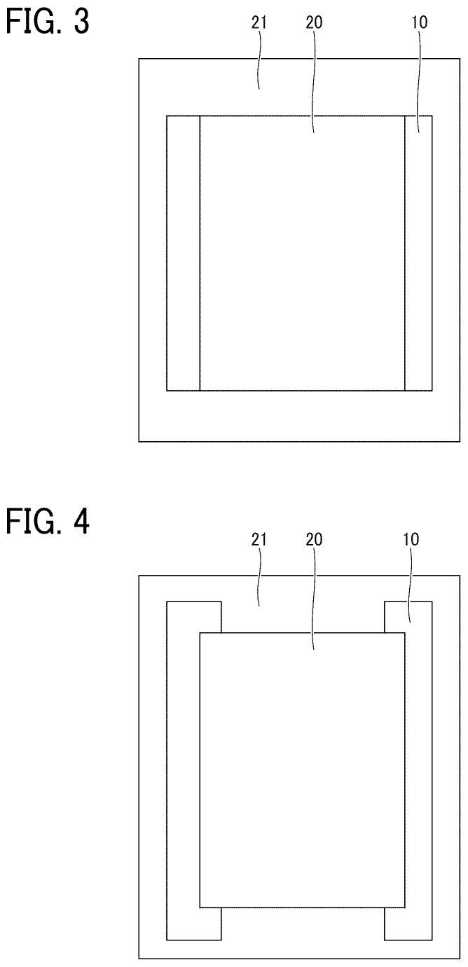

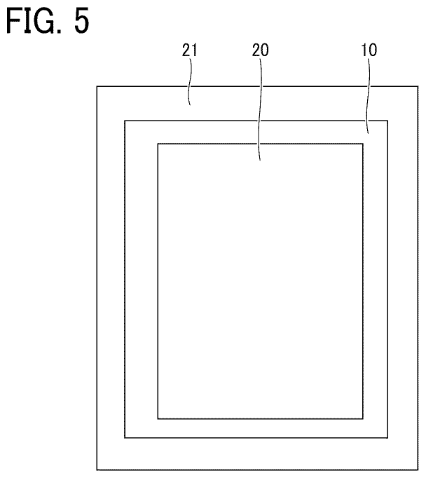

FIG. 3 is a schematic diagram illustrating a top view of an electrode for an electrochemical element according to one embodiment of the present disclosure. FIG. 4 is a schematic diagram illustrating a top view of an electrode for another electrochemical element according to one embodiment of the present disclosure. FIG. 5 is a schematic diagram illustrating a top view of an electrode for yet another electrochemical element according to one embodiment of the present disclosure.

In FIG. 3, the insulating resin layer 10 is provided in contact with two sides of the outer periphery of the first electrode composite layer 20.

In FIG. 4, the insulating resin layer 10 is provided in contact with the two long sides of the outer periphery of the first electrode composite layer 20, as well as to the two corners of those long sides.

In FIG. 5, the insulating resin layer 10 is provided continuously in contact with all four sides of the outer periphery of the first electrode composite layer 20. The insulating resin layer may also be provided in contact with the sides in a discontinuous manner.

In the present specification, “arranged on the outer periphery of the electrode composite layer” means that the insulating resin layer may be arranged on at least two sides of the outer periphery of the electrode composite layer, on three sides of the outer periphery of the electrode composite layer, or on all four sides of the outer periphery of the electrode composite layer. Additionally, the insulating resin layer may have recesses or notches on any side for the protrusion of electrode tabs.

As used in this specification, “arranged on the outer periphery of the substrate” means that the insulating resin layer may be arranged so as to cover the edge of the substrate, or it may be arranged in such a way that the substrate is exposed, as illustrated in FIGS. 3 to 5.

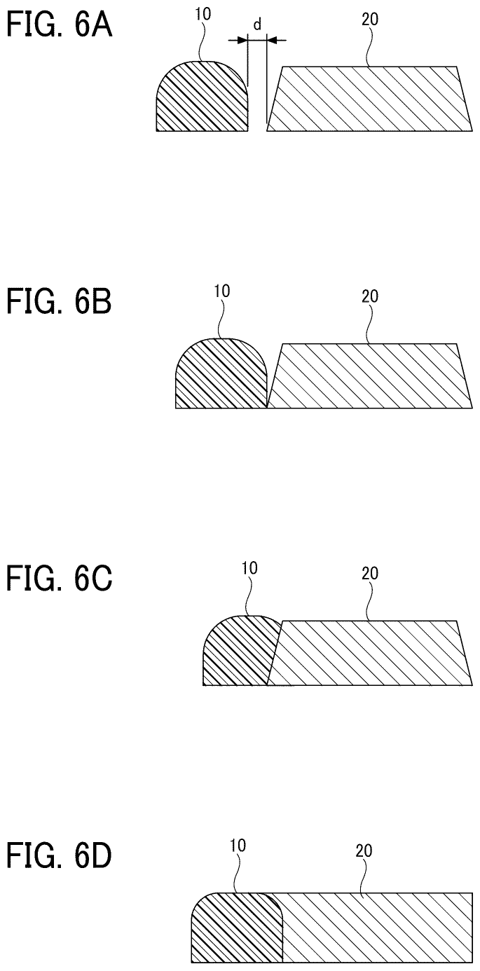

FIG. 6A is a schematic diagram illustrating a cross sectional view (part 1) of a positional relationship between the insulating resin layer and electrode composite layer in an electrode for electrochemical element according to an embodiment of the present disclosure. FIG. 6B is a schematic diagram illustrating a cross sectional view (part 2) of a positional relationship between the insulating resin layer and electrode composite layer in an electrode for electrochemical element according to an embodiment of the present disclosure. FIG. 6C is a schematic diagram illustrating a cross sectional view (part 3) of a positional relationship between the insulating resin layer and electrode composite layer in an electrode for electrochemical element according to an embodiment of the present disclosure. FIG. 6D is a schematic diagram illustrating a cross sectional view (part 4) of a positional relationship between the insulating resin layer and electrode composite layer in an electrode for electrochemical element according to an embodiment of the present disclosure.

The insulating resin layer 10 may be spaced apart from the first electrode composite layer 20, as illustrated in FIG. 6A, or it may be in contact with the first electrode composite layer 20, as illustrated in FIGS. 6B to 6D. Among these configurations, it is preferable for the insulating resin layer 10 to be in contact with the first electrode composite layer 20.

In the case in which the insulating resin layer 10 is in contact with the first electrode composite layer 20, the facing surfaces of the insulating resin layer 10 and the first electrode composite layer 20 may be partially in contact, as illustrated in FIG. 6B, or they may be in full contact, as illustrated in FIGS. 6C to 6D.

If the first electrode composite layer 20 is provided after the formation of the insulating resin layer 10, the first electrode composite layer 20 overlaps with the insulating resin layer 10, as illustrated in FIG. 6C. Similarly, if the insulating resin layer 10 is provided after the formation of the first electrode composite layer 20, the insulating resin layer 10 overlaps with the first electrode composite layer 20, as illustrated in FIG. 6D.

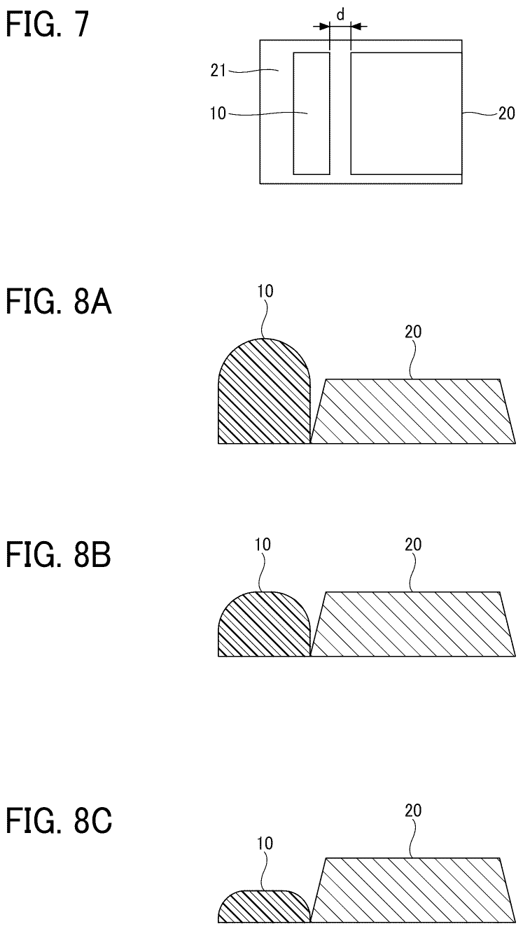

FIG. 7 is a schematic diagram illustrating a top view of a positional relationship between the insulating resin layer and electrode composite layer in an electrode for electrochemical element according to an embodiment of the present disclosure.

If the insulating resin layer 10 and the first electrode composite layer 20 are spaced apart, a distance d between the insulating resin layer 10 and the first electrode composite layer 20 (the distance between the outer periphery of the first electrode composite layer 20 and the insulating resin layer) is defined as illustrated in FIG. 7. That is, if the insulating resin layer 10 and the first electrode composite layer 20 are adjacent, the distance is d=0, and the distance d between the insulating resin layer and the electrode composite layer is defined as the distance between the arrows illustrated in FIG. 7. In cases where the insulating resin layer overlaps the electrode composite layer, as illustrated in FIGS. 6C and 6D, or where the electrode composite layer overlaps the insulating resin layer, a negative value is used to represent this distance.

There are no particular restrictions on the distance d between the insulating resin layer 10 and the first electrode composite layer 20 (the distance between the outer periphery of the first electrode composite layer 20 and the insulating resin layer), and it can be appropriately selected based on the purpose. It is preferable for the distance to be at most 10 mm, more preferably at most 5 mm, and even more preferably at most 1 mm.

A distance d between the insulating resin layer 10 and the first electrode composite layer 20 of at most 10 mm makes it easier for the insulating resin layer and the electrode composite layer to come into contact after a pressing process, suitably leading to the formation of a uniform solid electrolyte layer on the insulating resin layer and the electrode composite layer. Moreover, when the solid electrolyte layer is pressed, it is preferable because uniform pressure can be applied to the solid electrolyte layer.

FIG. 8A is a schematic diagram illustrating a cross sectional view (part 1) of a relationship of the average thickness between the insulating resin layer and electrode composite layer in an electrode for electrochemical element according to an embodiment of the present disclosure. FIG. 8B is a schematic diagram illustrating a cross sectional view (part 2) of a relationship of the average thickness between the insulating resin layer and electrode composite layer in an electrode for electrochemical element according to another embodiment of the present disclosure. FIG. 8C is a schematic diagram illustrating a cross sectional view (part 3) of a relationship of the average thickness between the insulating resin layer and electrode composite layer in an electrode for electrochemical element according to yet another embodiment of the present disclosure.

There are no particular restrictions on the relationship between the average thickness A of the electrode composite layer and the average thickness B of the insulating resin layer in the electrode laminate relating to the present disclosure, and the thicknesses can be appropriately selected depending on the purpose. For example, as illustrated in FIGS. 8A to 8C, A<B, A=B, or A>B may all be acceptable. Among these, A=B or A<B is preferable.

There are no particular restrictions on the average thickness of the insulating resin layer, and it can be appropriately selected according to various conditions such as the average thickness of the electrode composite layer. It is preferably 1.0 μm to 150.0 μm, and more preferably 10.0 μm to 100.0 μm.

An average thickness of the insulating resin layer of at least 10.0 μm can suitably distribute the pressure load during pressing and prevent short circuits between the positive and negative electrodes.

If the average thickness of the insulating resin layer is at most 100.0 μm, it is possible to manufacture an electrochemical element with high density and excellent battery characteristics.

There are no particular restrictions on the ratio (B/A) of the average thickness B of the insulating resin layer to the average thickness A of the electrode composite layer in the electrode laminate of the present disclosure, and it can be appropriately selected depending on the purpose. It is preferably 0.97 to 1.03, and more preferably 0.98 to 1.02.

There are no particular restrictions on the method of measuring the average thickness A of the electrode composite layer and the average thickness B of the insulating resin layer, and it can be appropriately selected depending on the purpose. For example, the thickness at three or more arbitrary points can be measured, and the average value can be calculated.

Since the insulating resin layer in the electrode laminate relating to the present disclosure has a porous structure, the thickness of the electrode composite layer and the insulating resin layer can be easily and precisely controlled through pressing.

Moreover, since the insulating resin layer can be formed by coating and polymerization-induced phase separation methods, the thickness can be easily controlled. If the insulating resin layer has a co-continuous structure, it can efficiently disperse the pressure generated during pressing, preventing issues such as damage to the insulating resin layer or unevenness regarding height, thus ensuring the production of a high-quality insulating resin layer.

There are no particular restrictions on the compression ratio of the insulating resin layer (after pressing at 500 MPa for 5 minutes), and it can be appropriately selected depending on the purpose. It is preferably between 1 percent and 50 percent, and more preferably between 5 percent and 20 percent.

A compression ratio of at most 50 percent enhances the strength of the insulating resin layer, ensuring adequate shape retention after the pressing process.

A compression ratio of at least 1 percent of the insulating resin layer alleviates the pressure on the solid electrolyte layer from the insulating layer during the pressing process after the sulfide solid electrolyte-containing layer is formed.

### Method of Manufacturing Electrode for Electrochemical Element and Apparatus for Manufacturing Electrode for Electrochemical Element

The method of manufacturing an electrode for electrochemical elements relating to the present disclosure includes forming an insulating resin layer, forming an electrode composite layer, and other optional processes.

The apparatus for manufacturing an electrode for an electrochemical element of the present disclosure includes a storage container, a device for forming an insulating resin layer, a device for forming an electrode composite layer, a device for removing the first solvent and the second solvent simultaneously, and other optional devices.

Note that the storage container, the insulating resin layer forming process, the insulating resin layer forming device, other processes, and other devices are similar to those described in the sections on Method of Manufacturing Laminate for Solid State Electrochemical Element and Device for Manufacturing Laminate for Solid State Electrochemical Element. Therefore, redundant descriptions are omitted.

### Electrode Composite Layer Forming Process and Electrode Composite Layer Forming Device

The process of forming an electrode composite layer is to form an electrode composite layer on a substrate.

The device for forming an electrode composite layer is to form an electrode composite layer on a substrate.

There are no particular limitations on the electrode composite layer forming process or device, and they can be appropriately selected according to the purpose. For example, one can use a method where a dispersion, obtained by dispersing substances such as powdery active materials, binders, and conductive materials in a liquid, is applied onto a substrate, fixed, and dried. In this process, application methods such as spraying, dispensing, die coating, or dip coating can be suitably employed.

In the method of manufacturing electrodes for electrochemical devices, there are no particular restrictions on the order of the insulating resin layer forming process and the electrode composite layer forming process.

Specifically, the electrode composite layer forming process may be performed before the insulating resin layer forming process, with the insulating resin layer being formed around the outer periphery of the electrode composite layer after its formation. In this case, the method of manufacturing electrodes for electrochemical devices involves performing the electrode composite layer forming process, the insulating resin layer forming process, and then the solvent removal process in that order.

Similarly, the electrode composite layer forming process may be performed after the insulating resin layer forming process, with the insulating resin layer being formed around the outer periphery of the substrate, and then the electrode composite layer being formed inside the insulating resin layer. In this case, the method of manufacturing electrodes for electrochemical devices involves performing the insulating resin layer forming process, the electrode composite layer formation process, and then the solvent removal process in that order.

### Method of Manufacturing Electrode Laminate and Device for Manufacturing Electrode Laminate

The method of manufacturing electrode laminate according to the present disclosure includes the insulating resin layer forming process, the electrode composite layer forming process, and the sulfide solid electrolyte-containing layer forming process. Additionally, it may optionally include a pressing process and other processes.

The device for manufacturing electrode laminate according to the present disclosure preferably includes a storage container, an insulating resin layer forming device, an electrode composite layer forming device, and a sulfide solid electrolyte-containing layer forming device. It may optionally also include pressing device and other devices.

Note that the storage container, the insulating resin layer forming process, the insulating resin layer forming device, the electrode composite layer forming device, the electrode composite layer forming device, other processes, and other devices are similar to those described in the sections on Method of Manufacturing Electrode for Electrochemical Device and Device for Manufacturing Electrode for Electrochemical Device and Method of Manufacturing Electrode for Electrochemical Element and Apparatus for Manufacturing Electrode for Electrochemical Element. Therefore, redundant descriptions are omitted.

### Pressing Process and Pressing Device

The pressing process is to press the electrode composite layer and insulating resin layer.

The pressing device is a device to press the electrode composite layer and insulating resin layer.

The pressing process can be suitably executed by the pressing device.

Regarding the pressing process and device, there are no particular restrictions; it can be performed using commercially available pressure molding equipment. The electrode composite layer and the insulating resin layer are possibly pressed in the substrate direction. Examples include, but are not limited to, uniaxial presses, roll presses, cold isostatic presses (CIP), and hot presses. Among these, cold isostatic presses (CIP), which can apply isotropic pressure, are preferred.

There are no particular restrictions on the timing of the pressing process; it can be appropriately selected according to the objective. For example, the electrode composite layer and the insulating resin layer can be pressed after being formed on the substrate, or the pressing can be done after the sulfide solid electrolyte-containing layer has been provided, or at both timings.

Carrying out the pressing process after forming the electrode composite layer and the insulating resin layer on the substrate, but before forming the sulfide solid electrolyte-containing layer, makes the average thickness of the electrode composite layer and the average thickness of the insulating resin layer approximately equal. This helps to distribute the pressure load, even if high pressure is applied during pressing the sulfide solid electrolyte-containing layer provided on the electrode.

Regarding the pressing pressure, there are no particular restrictions, and it can be appropriately selected according to the objective; however, it is preferable to apply a pressure that enables the substrate and the electrode composite layer to be bonded and densification of the electrode composite layer at the same time. More specifically, a pressure between 1 MPa and 900 MPa is preferable, and a range between 250 MPa and 700 MPa is even more preferable.

### Process of Forming Sulfide Solid Electrolyte-Containing Layer and Device for Forming Sulfide Solid Electrolyte-Containing Layer

The process of forming a sulfide solid electrolyte-containing layer in the method of manufacturing an electrode laminate involves forming a sulfide solid electrolyte-containing layer on the electrode composite layer and the insulating resin layer.

The device for forming a sulfide solid electrolyte-containing layer in the apparatus for manufacturing an electrode laminate refers to the device for forming a sulfide solid electrolyte-containing layer on the electrode composite layer and the insulating resin layer.

In the method of manufacturing an electrode laminate, there are no particular restrictions on the order of the insulating resin layer forming process and the electrode composite layer forming process. Specifically, the electrode composite layer forming process may be performed before the insulating resin layer forming process, with the insulating resin layer being formed around the outer periphery of the electrode composite layer after its formation. In that case, the method of manufacturing the electrode laminate is carried out in the following order: the electrode composite layer forming process, the insulating resin layer forming process, the sulfide solid electrolyte-containing layer forming process, the pressing process.

Similarly, the electrode composite layer forming process may be performed after the insulating resin layer forming process, with the insulating resin layer being formed around the outer periphery of the substrate, and then the electrode composite layer being formed inside the insulating resin layer. In that case, the method of manufacturing the electrode laminate is carried out in the following order: the insulating resin layer forming process, the solvent removal process, the electrode composite layer forming process, the pressing process, and the sulfide solid electrolyte-containing layer forming process.

### Embodiment for Forming Insulating Resin Layer or Electrode Laminate by Directly Applying Liquid Composition to Substrate

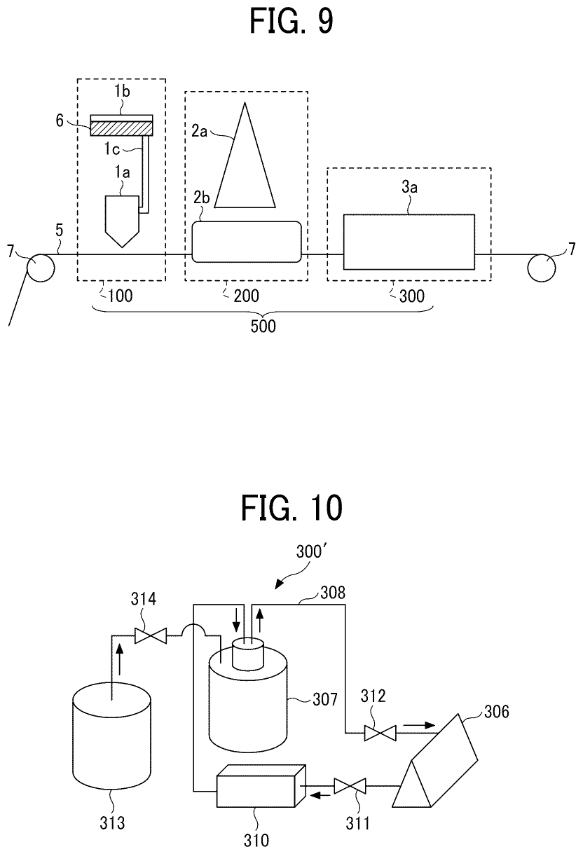

FIG. 9 is a schematic diagram illustrating an example of a device (liquid discharging device) for manufacturing an insulating resin layer to execute the method of manufacturing the electrode laminate relating to the present disclosure.

An insulating resin layer manufacturing device 500 includes a conveyance unit 5, a printing unit 100, a polymerization unit 200, a heating unit 300, and a roller 7.

The conveyance unit 5 conveys a printing substrate at a preset speed in the order of the printing unit 100, the polymerization unit 200, and the heating unit 300.

The printing substrate may have an electrode composite layer thereon, or it may be without an electrode composite layer. If the substrate does not have an electrode composite layer, the electrode composite layer is provided after the formation of the insulating resin layer.

### Printing Unit 100

The printing unit 100 includes a printing device 1a as an example of the application device, a storage container 1b that contains a liquid composition 6, and a supply tube 1c that supplies the liquid composition 6 stored in the storage container 1b to the printing device 1a.

The printing unit 100 discharges the liquid composition 6 from the printing device 1a onto the printing substrate, forming the liquid composition into a thin film. The storage container 1b may be configured to be integrated with or detachable from the insulating resin layer manufacturing device. Additionally, the storage container 1b may be designed to add materials to a container that is either integrated with or detachable from the insulating resin layer manufacturing device.

There are no particular limitations on the storage container 1b and supply tube 1c as long as they can stably store and supply the liquid composition 6, and they can be appropriately selected according to the purpose.

It is preferable that the materials constituting the storage container 1b and supply tube 1c have light-shielding properties in the relatively short wavelength regions of ultraviolet and visible light. Such materials are preferred to prevent the liquid composition 6 from initiating polymerization due to exposure to external light.

### Polymerization Unit 200

As illustrated in FIG. 9, in the case of photopolymerization, the polymerization unit 200 includes a light irradiation device 2a, which is an example of a liquid composition curing device for carrying out the liquid composition curing process, and a polymerization inert gas circulation device 2b, which circulates an inert gas for polymerization.

The light irradiation device 2a irradiates the thin film-like liquid composition formed by the printing unit 100 with light in the presence of a polymerization inert gas, initiating photopolymerization to obtain an insulating resin layer precursor.

The light irradiation device 2a is not particularly limited as long as it can initiate and progress the polymerization of compounds in the liquid composition. It can be selected appropriately according to the absorption wavelength of the photopolymerization initiator contained in the liquid composition. Examples include, but are not limited to, ultraviolet light sources such as high-pressure mercury lamps, metal halide lamps, thermal positive electrode tubes, cold positive electrode tubes, and LEDs. However, since light with shorter wavelengths tends to penetrate more deeply, it is preferable to select the light source according to the thickness of the insulating resin layer to be formed.

The polymerization inert gas circulation device 2b reduces the concentration of polymerization-active oxygen in the atmosphere to prevent the inhibition of polymerization reactions of polymerizable compounds near the surface of the liquid composition. Inert gases for polymerization include, for example, nitrogen, carbon dioxide, and argon.

It is preferable to maintain the O₂ concentration in the inert gas below 20 percent (a lower oxygen concentration than in the atmosphere) to achieve a greater inhibition reduction effect. More preferably, the O₂ concentration should be between 0 and 15 percent, and even more preferably between 0 and 5 percent.

Additionally, it is preferable for the polymerization inert gas circulation device 2b to be equipped with a temperature control device to ensure stable polymerization conditions.

The polymerization unit 200 may be a heating device in the case of thermal polymerization. There are no particular limitations on the heating device, and it can be appropriately selected according to the purpose. Examples include, but are not limited to, substrate heating (such as hot plates), IR heaters, and hot air heaters, which may also be used in combination.

Additionally, the heating temperature and time, or the conditions for light irradiation, can be appropriately selected according to the polymerizable compounds contained in the liquid composition and the thickness of the formed film.

There are no particular limitations on the polymerization unit 200, and it can be appropriately selected according to the purpose, such as the polymerization initiator or polymerization method to be used.

For example, a light irradiation device that emits ultraviolet light with a wavelength of 365 nm for 3 seconds can be used in the case of photopolymerization, and a heating device that heats at 150 degrees C. under vacuum for 12 hours can be used in the case of thermal polymerization.

### Heating Unit 300

The heating unit 300 includes a heating device 3a, which is an example of a solvent removal device for carrying out the solvent removal process.

As illustrated in FIG. 9, the heating device 3a heats the insulating resin layer precursor formed by the polymerization unit 200 to dry and remove any remaining solvent. At this time, the solvent removal process may be conducted under reduced pressure.

The heating unit 300 executes a polymerization promotion process of heating the insulating resin layer precursor with the heating device 3a to further accelerate the curing (polymerization) reaction performed in the polymerization unit 200.

Additionally, it carries out an initiator removal process of heating and drying them with the heating device 3a to remove any remaining photopolymerization initiators in the insulating resin layer precursor. These polymerization promotion and initiator removal processes do not need to be conducted simultaneously with the solvent removal process; they may be performed before or after the solvent removal process.

The heating unit 300 also carries out a polymerization completion process, where the insulating resin layer is heated under reduced pressure after the solvent removal process.

FIG. 10 is a schematic diagram illustrating another example of a device (liquid discharging device) for manufacturing an insulating resin layer to execute the method of manufacturing an electrode laminate according to one embodiment of the present disclosure.

A liquid discharging device 300′ allows the liquid composition to circulate through a liquid discharging head 306, a liquid discharging head tank 307, and a tube 308 by adjusting a pump 310 and valves 311 and 312.

The liquid discharging device 300′ is equipped with an external tank 313, allowing the liquid composition to be supplied from the external tank 313 to the liquid discharging head tank 307 by adjusting the pump 310 and operating the valves 311, 312, and 314 when the liquid composition in the liquid discharging head tank 307 decreases.

The device for manufacturing the insulating resin layer allows the liquid composition to be discharged precisely onto the targeted areas of an object.

The insulating resin layer manufacturing device 500 may be equipped with a mechanism to cap the nozzle to prevent drying when the liquid composition 6 is not being discharged from the liquid discharging head.

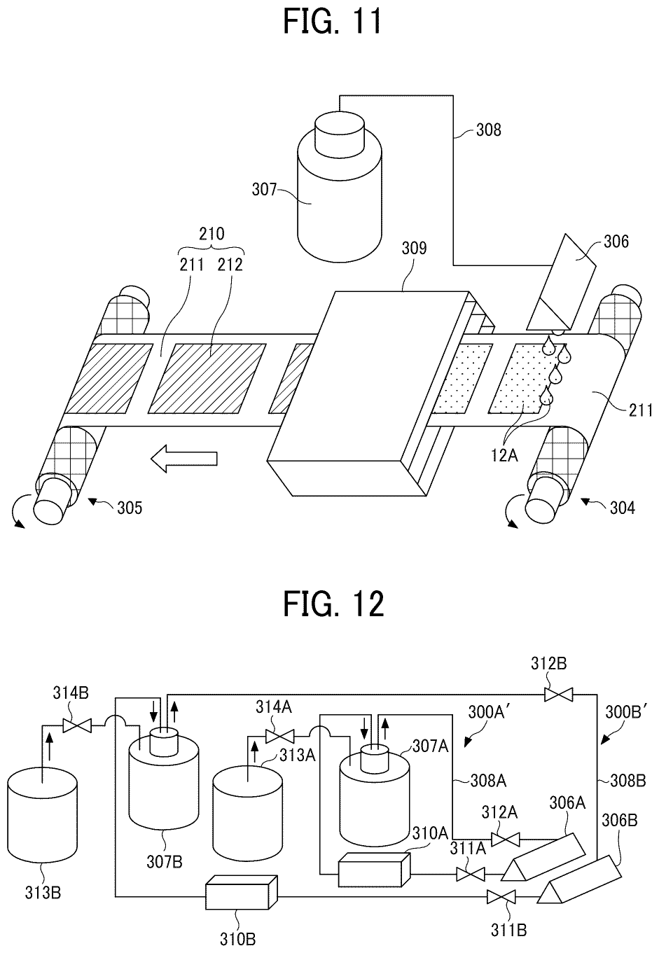

FIG. 11 is a schematic diagram (part 1) illustrating a method of manufacturing an electrode for an electrochemical element according to one embodiment of the present disclosure.

The method of manufacturing an electrode 210 for an electrochemical element, which has an insulating resin layer formed on a substrate, includes a process of sequentially discharging a liquid composition 12A onto a substrate 211 using the liquid discharging device 300′.

First, a slender substrate 211 is prepared. The substrate 211 is then wound around a cylindrical core, with the side where the insulating resin layer 212 is to be formed facing upwards as illustrated in FIG. 11, and is placed between a feed roller 304 and a take-up roller 305. The feed roller 304 and the take-up roller 305 rotate counterclockwise to convey the substrate 211 from right to left in FIG. 11. Then in the same manner as in FIG. 10, the liquid discharging head 306 positioned above the substrate 211 sequentially discharges droplets of the liquid composition 12A onto the substrate 211, which is conveyed between the feed roller 304 and the take-up roller 305.

Note that two or more of the liquid discharging heads 306 can be positioned in the direction substantially parallel or perpendicular to the conveyance direction of the substrate 211.

Next, the substrate 211, onto which the droplets of liquid composition 12A have been discharged, is conveyed to the polymerization unit 309 by the feed roller 304 and the take-up roller 305. As a result, the liquid composition 12A is polymerized to form the insulating resin layer 212, resulting in an electrode 210 for the electrochemical element with an insulating resin layer on the substrate. Subsequently, the electrode 210 for the electrochemical element is cut to a desired size through processes such as punching.

The polymerization unit 309 may be installed on either the upper or lower side of the substrate 211, or multiple units may be disposed.

The polymerization unit 309 is not particularly limited as long as it does not directly contact the liquid composition 12A, and can be appropriately selected according to the intended purpose. For example, in the case of thermal polymerization, options include resistance heating heaters, infrared heaters, and fan heaters, while in the case of photopolymerization, ultraviolet irradiation devices can be used. Two or more of the polymerization unit 309 can be disposed.

There is no specific limitation to the conditions for heating or light irradiation. It can be selected to suit to a particular application.

FIG. 12 is a schematic diagram illustrating another example of a device (liquid discharging device) for manufacturing an insulating resin layer to execute the method of manufacturing an electrode laminate according to one embodiment of the present disclosure.

The liquid discharging devices 300A′ and a 300B′ may be used in combination. Specifically, the liquid composition may be supplied from external tanks 313A and 313B connected to liquid discharging head tanks 307A and 307B, respectively, and the liquid discharging heads may include multiple heads 306A and 306B. Additionally, the system may include tubes 308A and 308B, valves 311A, 311B, 312A, 312B, 314A, and 314B, as well as pumps 310A and 310B.

### Embodiment for Forming Insulating Resin Layer or Electrode Laminate by Indirectly Applying Liquid Composition to Substrate

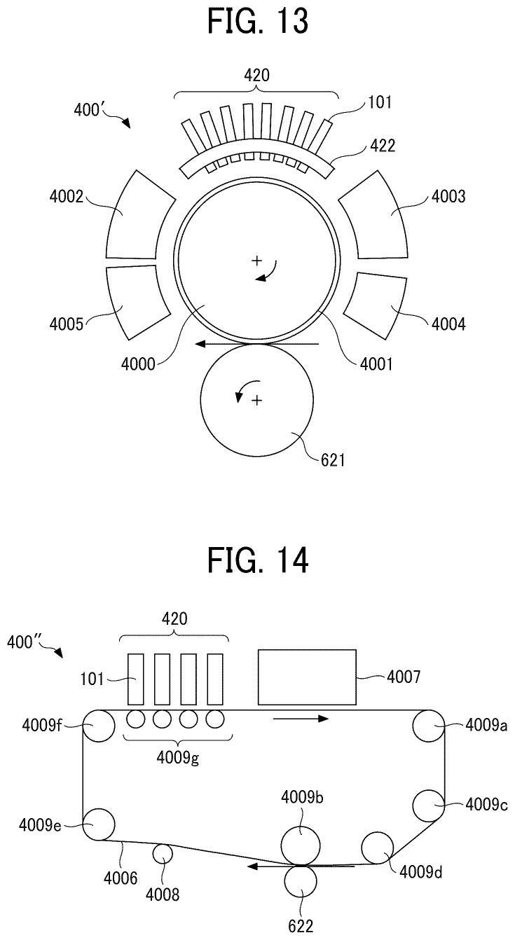

FIG. 13 is a configuration diagram (part 1) illustrating an example of a printing unit in which an inkjet method and a transfer method are adopted as the liquid composition application device in an insulating resin layer manufacturing device according to an embodiment of the present disclosure. In the printing unit illustrated in FIG. 13, a drum-shaped intermediate transfer body is used.

A printing unit 400′ is an inkjet printer that forms an insulating resin layer on a substrate by transferring the liquid composition or the insulating resin layer onto the substrate via an intermediate transfer member 4001.

The printing unit 400′ includes an inkjet unit 420, a transfer drum 4000, a pretreatment unit 4002, an absorption unit 4003, a heating unit 4004, and a cleaning unit 4005.

The inkjet unit 420 includes a head module 422 carrying multiple heads 101.

The heads 101 discharge a liquid composition to the intermediate transfer member 4001 supported by the transfer drum 4000 to form a liquid composition layer on the intermediate transfer member 4001. Each of the heads 101 is a line head. The nozzles thereof are disposed to cover the width of the printing region of the maximally usable substrate. The heads 101 have a nozzle surface formed with nozzles on its lower side, and the nozzle surface faces the surface of the intermediate transfer member 4001 through a minute gap. In the present embodiment, the intermediate transfer member 4001 is configured to move circularly on a circular orbit. The heads 101 are thus radially positioned.

The transfer drum 4000 faces an impression cylinder 621 and forms a transfer nip. The pretreatment unit 4002 may apply a reaction liquid to the intermediate transfer member 4001 to increase the viscosity of a liquid composition before the heads 101 discharge the liquid composition.

The absorption unit 4003 absorbs the liquid component from the liquid composition on the intermediate transfer member 4001 before transferring.

The heating unit 4004 heats the liquid composition on the intermediate transfer member 4001 before transferring. Heating initializes thermal polymerization of the liquid composition, forming an insulating resin layer. The solvent is also removed, thereby enhancing the transferability to the substrate.

The cleaning unit 4005 cleans the intermediate transfer member 4001 after the transfer process and removes ink and contaminants, such as dust, that remain on the intermediate transfer member 4001.

The outer surface of the impression cylinder 621 is in press contact with the intermediate transfer member 4001, allowing the insulating resin layer on the intermediate transfer member 4001 to be transferred to the substrate when it passes through the transfer nip between the impression cylinder 621 and the intermediate transfer member 4001. The impression cylinder 621 can be configured to include at least one gripping mechanism for holding the front end of the substrate on its outer surface.

FIG. 14 is a configuration diagram (part 2) illustrating an example of a printing unit in which an inkjet method and a transfer method are adopted as the liquid composition application device in an insulating resin layer manufacturing device according to an embodiment of the present disclosure. The printing unit 14 has an intermediate transfer member having an endless belt form.

A printing unit 400″ is an inkjet printer that forms an insulating resin layer on a substrate by transferring the liquid composition or the insulating resin layer onto the substrate via an intermediate transfer belt 4006.

The printing unit 400″ is equipped with an inkjet unit 420, a transfer roller 622, the intermediate transfer belt 4006, a heating unit 4007, a cleaning roller 4008, a drive roller 4009a, a counter roller 4009b, a shape-maintaining roller 4009c, a shape-maintaining roller 4009d, a shape-maintaining roller 4009e, and a shape-maintaining roller 4009f.

The printing unit 400″ discharges liquid droplets of the liquid composition from the heads 101 of the inkjet unit 420 onto the outer surface of the intermediate transfer belt 4006. The liquid composition on the intermediate transfer belt 4006 is heated by the heating unit 4007 and forms an insulating resin layer through thermal polymerization. The insulating resin layer on the intermediate transfer belt 4006 is transferred to the substrate at the transfer nip where the intermediate transfer belt 4006 faces the transfer roller 622. After transfer, the cleaning roller 4008 cleans the surface of the intermediate transfer belt 4006.

The intermediate transfer belt 4006 is stretched over a drive roller 4009a, a counter roller 4009b, multiple shape-maintaining rollers 4009c, 4009d, 4009e, 4009f, and several support rollers 4009g, and moves in the direction indicated by the arrow in FIG. 14. The support rollers 4009g disposed facing the heads 101 maintain the tension of the intermediate transfer belt 4006 when the heads 101 discharge ink droplets.

### Electrochemical Element

The electrochemical element relating to the present disclosure preferably includes an electrode laminate, and may optionally have an outer casing as well.

Note that the electrode laminate is the same as described in the section on Electrode Laminates, so redundant descriptions are omitted.

An embodiment of the electrochemical element relating to the present disclosure is described with reference to the drawings. The present disclosure is not limited to these embodiments.

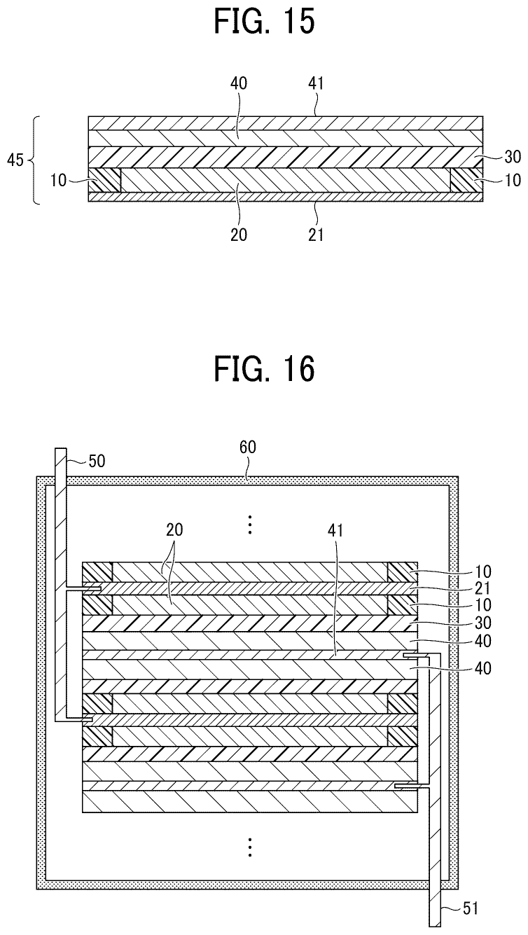

FIG. 15 is a schematic cross-sectional view illustrating the electrochemical element according to one embodiment of the present disclosure. The electrochemical element 45 includes a first substrate 21, a first electrode composite layer 20 disposed on the first substrate 21, an insulating resin layer 10 disposed on the outer periphery of the first electrode composite layer 20, a sulfide solid electrolyte-containing layer 30 disposed on the first electrode composite layer 20 and the insulating resin layer 10, a second electrode composite layer 40 disposed on the sulfide solid electrolyte-containing layer 30, and a second substrate 41 disposed on the second electrode composite layer 40. The electrochemical element 45 is a single-cell layer, and this can be laminated to form a stacked battery.

Note that FIG. 15 illustrates the configuration in which the first electrode composite layer 20, the insulating resin layer 10, and the sulfide solid electrolyte-containing layer 30 are provided on one side of the first substrate 21, but the first electrode composite layer 20, the insulating resin layer 10, and the sulfide solid electrolyte-containing layer 30 may be provided on both opposing sides of the first substrate 21. This configuration may be laminated to form a stacked battery.

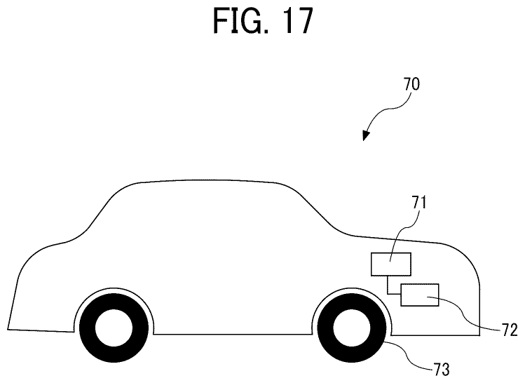

FIG. 16 is a schematic cross-sectional view illustrating an example of a solid state battery, which is an electrochemical element according to one embodiment of the present disclosure.

The solid state battery illustrated in FIG. 16 includes a positive electrode (first electrode composite layer) 20, a negative electrode (second electrode composite layer) 40, a sulfide solid electrolyte-containing layer 30, lead wires 50 and 51, and an outer casing 60.

The positive electrode (first electrode composite layer) 20 includes a positive electrode substrate 21 and an insulating resin layer 10 disposed on the positive electrode substrate 21. The lead wire 50 is connected to the positive electrode substrate 21, and the lead wire 51 is connected to the negative electrode substrate 41. The lead wires 50 and 51 are drawn out to the outside of the outer casing 60.

In the solid state battery, the positive electrode (first electrode composite layer) 20 and the negative electrode (second electrode composite layer) 40 are stacked via the sulfide solid electrolyte-containing layer 30, and the positive electrode (first electrode composite layer) 20 is disposed on both sides of the negative electrode (second electrode composite layer) 40. Note that there is no particular limit on the number of stacks of the positive electrodes (first electrode composite layer) 20 and the negative electrodes (second electrode composite layer) 40. Also, the number of positive electrodes (first electrode composite layers) 20 and negative electrodes (second electrode composite layers) 40 may be the same or different.

As for the outer casing, there is no particular limitation as long as it can seal the electrode laminate, and a known outer casing can be appropriately selected depending on the purpose.

The shape of the electrochemical element is not particularly limited and can be appropriately selected depending on the purpose. For example, it may be a laminate type, cylinder type, or coin type.

In electrochemical devices where short circuits can potentially occur due to dendrite deposition, it is generally common to configure the negative electrode composite layer to be larger than the positive electrode composite layer. In this case, if the positive and negative current collectors are approximately the same size, a surplus area where the positive electrode composite layer is not formed will be present in the region on the positive current collector where it faces the negative electrode composite layer. In term of electrochemical element properties, it is preferable that the insulating resin layer be provided in the surplus area of the positive electrode, that is, at the outer periphery of the positive electrode composite layer. However, if the configuration is such that the negative electrode composite layer is smaller than the positive electrode composite layer in an electrochemical element, it is preferable that the insulating resin layer be provided in the surplus area of the negative electrode, that is, at the outer periphery of the negative electrode composite layer.

### Method of Manufacturing Electrochemical Element and Apparatus for Manufacturing Electrochemical Element

The method for manufacturing an electrochemical element relating to the present disclosure preferably includes an insulating resin layer forming process, an electrode composite layer forming process, a pressing process, a sulfide solid electrolyte-containing layer forming process, a device forming process, and an electrode processing process, and may also include other optional processes.

The apparatus for manufacturing an electrochemical element relating to the present disclosure preferably includes an insulating resin layer forming device, an electrode composite layer forming device, a pressing device, a sulfide solid electrolyte-containing layer forming device, an element forming device, and an electrode processing device, and may also include other optional devices.

Since the insulating resin layer forming process, insulating resin layer forming device, electrode composite layer forming process, electrode composite layer forming device, pressing process, pressing device, sulfide solid electrolyte-containing layer forming process, sulfide solid electrolyte-containing layer forming device, other processes, and other devices are the same as those described in the sections on Method of Manufacturing Laminate for Solid State Electrochemical Element and Apparatus for Manufacturing Laminate for Solid State Electrochemical Element, Method of Manufacturing Electrode for Electrochemical Element and Apparatus for Manufacturing Electrode for Electrochemical Element, and Method of Manufacturing Electrode Laminate and Apparatus for Manufacturing Electrode Laminate, the repetitive descriptions are omitted.

### Element Forming Process and Element Forming Device

The element forming process is for manufacturing an electrochemical element using an electrode laminate.

The element forming device is for manufacturing an electrochemical element using an electrode laminate.

There are no particular restrictions on the method of manufacturing an electrochemical element using an electrode laminate, and an appropriate, known method of manufacturing an electrochemical element may be selected according to a particular application. For example, it may include at least one of placing counter electrodes, winding or laminating, and housing in a container to form an energy storage element.

Note that the element forming process does not need to include all processes of element forming and may include only a part of the processes involved in element forming.

### Electrode Processing Process and Electrode Processing Device

The electrode processing process is for processing an electrode with a formed insulating resin layer, conducted after the liquid composition application process in the insulating resin layer forming process. The electrode processing process may include at least one of a cutting process, folding process, and laminating process.

The electrode processing device is for processing an electrode with a formed insulating resin layer. The electrode processing device may include at least one of a cutting device, folding device, and laminating device.

For example, the electrode processing device may cut the electrode with a formed insulating resin layer to create an electrode laminate. The electrode processing device may, for example, wind or laminate the electrode laminate with a formed insulating resin layer. The electrode processing device may, for example, include an electrode processing device that performs cutting, accordion folding, laminating, or winding of the electrode laminate with a formed insulating resin layer according to the desired battery format.

The application of the electrochemical device is not particularly limited and it can be suitably selected to suit to a particular application.

Examples include, but are not limited to: mobile objects such as vehicles; and electric devices, such as mobile phones, notebook computers, pen-input personal computers, mobile personal computers, electronic book players, cellular phones, portable facsimiles, portable copiers, portable printers, headphone stereos, video movies, liquid crystal televisions, handy cleaners, portable compact discs (CDs), minidiscs, transceivers, electronic notebooks, calculators, memory cards, portable tape recorders, radios, backup power supplies, motors, lighting devices, toys, game machines, watches, strobes, and cameras. Of these, vehicles and electric devices are preferable.

The vehicles include, but are not limited to, ordinary vehicles, heavy special cars, small special vehicles, trucks, heavy motorcycles, and ordinary motorcycles.

An embodiment of the mobile object as the electrochemical element relating to the present disclosure is described with reference to the drawings. The present disclosure is not limited to these embodiments.

### Mobile Object

FIG. 17 is a schematic diagram illustrating a mobile object, which is an electrochemical element according to an embodiment of the present disclosure.

A mobile object 70 is an electric vehicle, for example. The mobile object 70 includes a motor 71, an electrochemical device 72, and wheels 73.

The electrochemical device 72 is an electrochemical device relating to the present disclosure. The electrochemical device 72 drives a motor 71 by supplying electricity to the motor 71. The motor 71 driven can drive the wheels 73, and as a result, the mobile object 70 can move.

Since the mobile object 70 is equipped with the electrochemical device 72, it prevents short circuits between the positive and negative electrodes, and is driven by the power from an electrochemical device that has excellent battery properties, allowing the vehicle to move safely and efficiently.

The mobile object 70 is not limited to an electric vehicle; it may be a plug-in hybrid vehicle (PHEV), a hybrid electric vehicle (HEV), and a locomotive or motorcycle that can operate using both a diesel engine and an electrochemical element. Additionally, the mobile object 70 could be a transport robot used in factories, capable of operating with only an electrochemical element or in combination with an engine and an electrochemical element. Furthermore, the mobile object 70 could be a device where not the entire object moves, but only a part of it, such as an assembly robot placed in a factory production line, which can operate using only an electrochemical element or in combination with an engine and an electrochemical element to move an arm or other components.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples and Comparative Examples but is not limited thereto. In the following Examples and Comparative Examples, “parts” represents “parts by mass” and, “percent”, “percent by mass”, unless otherwise specified.

### Preparation of Liquid Composition

As illustrated in Tables 1 to 3, the polymerizable compound, solvent, and photopolymerization initiator (1-Benzoylcyclohexanol, available from Tokyo Chemical Industry Co., Ltd.) were admixed, resulting in Liquid Compositions 1 to 42 and Comparative Liquid Compositions 1 to 6. The amount of photopolymerization initiator added was 1 percent by mass to the entire of the polymerizable compound.

TABLE 1

| | Poor polymerizable | | | | | | |
|---|---|---|---|---|---|---|---|
| | compound | | Good | | | | |
| | | Mass | polymerizable | | | | |
| | | ratio | compound | | Solvent | Poor solvent | |
| Liquid | | (mixing | | Mass | soluble | | Mass |
| composition | Material | ratio Y) | Material | ratio | point | Material | ratio |
| 1 | #230D | 1.00 | — | — | — | p-menthane | 0.28 |
| 2 | #230D | 1.00 | — | — | — | p-menthane | 0.23 |
| 3 | #230D | 1.00 | — | — | — | p-menthane | 0.18 |
| 4 | #230D | 1.00 | — | — | — | p-menthane | 0.13 |
| 5 | #230D | 1.00 | — | — | — | Decane | 0.57 |
| 6 | #230D | 1.00 | — | — | — | p-menthane | 0.53 |
| 7 | #230D | 1.00 | — | — | — | Decane | 0.70 |
| 8 | #230D | 1.00 | — | — | | EXXSOL | 0.60 |
| | | | | | | D40 | |
| 9 | #230D | 1.00 | — | — | — | IsoperH | 0.60 |
| 10 | #230D | 1.00 | — | — | — | IsoperI | 0.67 |
| 11 | #230D | 0.25 | HPP-A | 0.75 | 25 | Decane | 0.87 |
| 12 | #230D | 0.50 | HPP-A | 0.50 | 50 | Decane | 0.75 |
| 13 | #230D | 0.75 | HPP-A | 0.25 | 75 | Decane | 0.65 |
| 14 | #230D | 0.45 | HPP-A | 0.55 | 45 | p-menthane | 1.00 |
| 15 | #230D | 0.05 | HPP-A | 0.95 | 5 | Decane | 1.00 |
| 16 | #230D | 0.25 | HPP-A | 0.75 | 25 | Decane | 0.90 |
| 17 | #230D | 0.50 | HPP-A | 0.50 | 50 | Decane | 0.77 |
| 18 | #230D | 0.75 | HPP-A | 0.25 | 75 | Decane | 0.67 |
| 19 | #230D | 1.00 | — | — | — | p-menthane | 0.50 |
| 20 | #230D | 1.00 | — | — | — | Decane | 0.70 |

| | Good solvent | | | |
|---|---|---|---|---|
| | | Mass | | |
| | | ratio | Polymerizable | Concentration |
| Liquid | | (mixing | compound | of solid |
| composition | Material | ratio X) | soluble point | portion |
| 1 | Diethylene | 0.72 | 72 | 50 percent |
| | glycol diethyl | | | |
| | ether | | | |
| 2 | Diethylene | 0.77 | 72 | 50 percent |
| | glycol diethyl | | | |
| | ether | | | |
| 3 | Diethylene | 0.82 | 72 | 50 percent |
| | glycol diethyl | | | |
| | ether | | | |
| 4 | Diethylene | 0.87 | 72 | 50 percent |
| | glycol diethyl | | | |
| | ether | | | |
| 5 | 2-Ethylhexyl | 0.43 | 43 | 50 percent |
| | Acetate | | | |
| 6 | Mesitylene | 0.47 | 47 | 50 percent |
| 7 | Mesitylene | 0.30 | 30 | 50 percent |
| 8 | 2-Ethylhexyl | 0.40 | 40 | 50 percent |
| | Acetate | | | |
| 9 | 2-Ethylhexyl | 0.40 | 40 | 50 percent |
| | Acetate | | | |
| 10 | 2-Ethylhexyl | 0.33 | 33 | 50 percent |
| | Acetate | | | |
| 11 | Mesitylene | 0.13 | 13 | 50 percent |
| 12 | Mesitylene | 0.25 | 15 | 50 percent |
| 13 | Mesitylene | 0.35 | 15 | 50 percent |
| 14 | — | — | — | 50 percent |
| 15 | — | — | — | 50 percent |
| 16 | 2-Ethylhexyl | 0.10 | 10 | 50 percent |
| | Acetate | | | |
| 17 | 2-Ethylhexyl | 0.23 | 13 | 50 percent |
| | Acetate | | | |
| 18 | 2-Ethylhexyl | 0.33 | 13 | 50 percent |
| | Acetate | | | |
| 19 | p-cymene | 0.50 | 50 | 50 percent |
| 20 | p-cymene | 0.30 | 30 | 50 percent |

TABLE 2

| | Poor polymerizable | | | | | | |
|---|---|---|---|---|---|---|---|
| | compound | | Good | | | | |
| | | Mass | polymerizable | | | | |
| | | ratio | compound | | Solvent | Poor solvent | |
| Liquid | | (mixing | | Mass | soluble | | Mass |
| composition | Material | ratio Y) | Material | ratio | point | Material | ratio |
| 21 | #230D | 0.25 | HPP-A | 0.75 | 25 | Decane | 0.87 |
| 22 | #230D | 0.50 | HPP-A | 0.50 | 50 | Decane | 0.75 |
| 23 | #230D | 0.75 | HPP-A | 0.25 | 75 | Decane | 0.62 |
| 24 | HX220D | 1.00 | — | — | — | p- | 0.53 |
| | | | | | | menthane | |
| 25 | HX220D | 1.00 | — | — | — | Decane | 0.75 |
| 26 | HX220D | 0.55 | HPP-A | 0.45 | 55 | p- | 1 |
| | | | | | | menthane | |
| 27 | HX220D | 0.10 | HPP-A | 0.90 | 10 | Decane | 1 |
| 28 | HX620D | 0.38 | HPP-A | 0.62 | 38 | p- | 1 |
| | | | | | | menthane | |
| 29 | PEG200DA | 0.23 | HPP-A | 0.77 | 23 | p- | 1 |
| | | | | | | menthane | |
| 30 | PEG200DA | 0.13 | HPP-A | 0.87 | 23 | p- | 1 |
| | | | | | | menthane | |
| 31 | PEG200DA | 0.03 | HPP-A | 0.97 | 23 | p- | 1 |
| | | | | | | menthane | |
| 32 | PEG200DA | 0.01 | HPP-A | 0.99 | 23 | p- | 1 |
| | | | | | | menthane | |
| 33 | CN2283NS | 1.00 | — | — | — | Decane | 0.62 |
| 34 | CN2283NS | 0.90 | HPPA | 0.10 | 90 | Decane | 0.65 |
| 35 | CN2283NS | 0.75 | HPPA | 0.25 | 75 | Decane | 0.7 |
| 36 | CN2283NS | 0.50 | HPPA | 0.50 | 50 | Decane | 0.77 |
| 37 | CN2283NS | 0.25 | HPPA | 0.75 | 25 | Decane | 0.87 |
| 38 | CN2283NS | 0.10 | HPPA | 0.90 | 10 | Decane | 0.97 |
| 39 | CN2283NS | 0.35 | HPPA | 0.35 | 50 | Decane | 0.77 |
| 40 | CN2283NS | 0.40 | HPPA | 0.40 | 50 | Decane | 0.77 |
| 41 | CN2283NS | 0.60 | HPPA | 0.60 | 50 | Decane | 0.77 |
| 42 | CN2283NS | 0.70 | HPPA | 0.70 | 50 | Decane | 0.77 |

| | Good solvent | | | |
|---|---|---|---|---|
| | | Mass | | |
| | | ratio | Polymerizable | Concentration |
| Liquid | | (mixing | compound | of solid |
| composition | Material | ratio X) | soluble point | portion |
| 21 | p-cymene | 0.13 | 13 | 50 percent |
| 22 | p-cymene | 0.25 | 25 | 50 percent |
| 23 | p-cymene | 0.38 | 38 | 50 percent |
| 24 | Diethylene glycol | 0.47 | 47 | 50 percent |
| | diethyl ether | | | |
| 25 | Tetrahydrolinalool | 0.25 | 25 | 50 percent |
| 26 | — | — | — | 50 percent |
| 27 | — | — | — | 50 percent |
| 28 | — | — | — | 50 percent |
| 29 | — | — | — | — |
| 30 | — | — | — | — |
| 31 | — | — | — | — |
| 32 | — | — | — | — |
| 33 | 2-Ethylhexyl | 0.38 | 38 | 50 percent |
| | Acetate | | | |
| 34 | 2-Ethylhexyl | 0.35 | 35 | 50 percent |
| | Acetate | | | |
| 35 | 2-Ethylhexyl | 0.3 | 30 | 50 percent |
| | Acetate | | | |
| 36 | 2-Ethylhexyl | 0.23 | 23 | 50 percent |
| | Acetate | | | |
| 37 | 2-Ethylhexyl | 0.13 | 13 | 50 percent |
| | Acetate | | | |
| 38 | 2-Ethylhexyl | 0.03 | 3 | 50 percent |
| | Acetate | | | |
| 39 | 2-Ethylhexyl | 0.23 | 23 | 41 percent |
| | Acetate | | | |
| 40 | 2-Ethylhexyl | 0.23 | 23 | 44 percent |
| | Acetate | | | |
| 41 | 2-Ethylhexyl | 0.23 | 23 | 55 percent |
| | Acetate | | | |
| 42 | 2-Ethylhexyl | 0.23 | 23 | 58 percent |
| | Acetate | | | |

TABLE 3

| | Poor polymerizable | | | | | | |
|---|---|---|---|---|---|---|---|
| | compound | | Good | | | | |
| | | Mass | polymerizable | | | | |
| Comparative | | ratio | compound | | Solvent | Poor solvent | |
| liquid | | (mixing | | Mass | soluble | | Mass |
| composition | Material | ratio Y) | Material | ratio | point | Material | ratio |
| 1 | #230D | 2.00 | — | — | — | — | — |
| 2 | — | — | HPP-A | 2.00 | — | — | — |
| 3 | CN2283NS | 2.00 | — | — | — | — | — |
| 4 | HX-220 | 2.00 | — | — | — | — | — |
| 5 | PEG200DA | 1.00 | — | — | — | Tetrahydro | 1 |
| | | | | | | linalool | |
| 6 | PEG200DA | 2.00 | — | — | — | — | — |

| | Good solvent | | | |
|---|---|---|---|---|
| | | Mass | | |
| Comparative | | ratio | Polymerizable | Concentration |
| liquid | | (mixing | compound | of solid |
| composition | Material | ratio X) | soluble point | portion |
| 1 | — | — | — | 100 percent |
| 2 | — | — | — | 100 percent |
| 3 | — | — | — | 100 percent |
| 4 | — | — | — | 100 percent |
| 5 | — | — | — | 50 percent |
| 6 | — | — | — | 100 percent |

The details of each material shown in Tables 1 to 3 are as follows.
VISCOAT® #230D (1,6-Hexanediol acrylic acid polymer ester, available from Osaka Organic Chemical Industry Ltd.)
KAYARAD HX220 (6-(Propionyloxy) hexanoic acid 3-[2,2-Dimethyl-3-[[(1-Oxo-6-(propionyloxy)hexyl]oxy]propoxy]-2,2-dimethyl-3-oxopropyl, available from Nippon Kayaku Co., Ltd.)
KAYARAD HX620 (Poly [oxy (l-oxo-1,6-hexanediyl)], α-hydro-ω-[(1-oxo-2-propenyl)oxy]-3-hydroxy-2,2-dimethylpropyl 3-hydroxy-2,2-dimethylpropanoate (9CI) diester, available from Nippon Kayaku Co., Ltd.)
CN2283NS (Polyester acrylate, available from Sartomer Company, Inc.)
Light Acrylate HPP-A (Neopentyl glycol hydroxypivalate acrylate adduct, available from Kyoeisha Chemical Co., Ltd.)
PEG200DA (PEG200 diacrylate, available from Daicel Ornitech Co., Ltd.)

### Example 1

### Preparation of Insulating Resin Layer

The liquid composition 1 was applied onto an aluminum foil (5 cm×5 cm, thickness: 20 μm) using a bar coater and then cured by ultraviolet irradiation (light source: UV-LED, product name: FJ800, available from Phoseon Technology), wavelength: 365 nm, irradiation intensity: 30 mW/cm², irradiation time: 20 s) directed at the coated area. Next, the cured product was heated using a hot plate at 120 degrees Celsius for 1 minute to remove the solvent, followed by additional drying at 120 degrees Celsius for 10 minutes to obtain Insulating Resin Layer 1 of Example 1, with an average thickness of 100 μm.

### Evaluation of Curl Development Reduction Effect

The maximum distance (maximum warping height) between the horizontal surface and the lower surface of the insulating resin layer of Example 1, as observed from the horizontal direction, was measured. The lower surface of the insulating resin layer refers to the surface opposite to the side facing the horizontal plane. Based on the measured maximum warping height, the curl development reduction effect was evaluated. The number of measurement samples was three, and the average value of these samples was used as the measurement result. It should be noted that a rating of B or above indicates that there are no issues in practical use. The results are shown in Tables 4 to 5.

### Evaluation Criteria for Curl Development Reduction Effect

A: Maximum warping height is at most 3 mm
B: Maximum warping height exceeds 3 mm but is less than 5 mm
C: Maximum warping height is at least 5 mm

### Synthesis of Sulfide Solid Electrolyte

The argyrodite-type sulfide solid electrolyte, Li₆PS₅Cl (LPSC), was synthesized as a sulfide solid electrolyte based on the synthesis method described in J. Power Sources, 2018, 396, 33-40. A specific method is as follows.

A total of 0.5 g of Li₂S (99.9 percent, available from Mitsuwa Chemical Co., Ltd.), 0.5 g of P₂S₅ (99 percent, available from Sigma-Aldrich Co. LLC.), and 0.5 g of LiCl (99 percent, available from Sigma-Aldrich Co. LLC.) were ground for 40 hours using a planetary ball mill (PULVERISETTE, available from Fritsch Germany) to obtain the sulfide solid electrolyte. The grinding was carried out in a zirconia pot (45 mL) using 15 zirconia balls (diameter: 10 mm) at 600 RPM.

### Preparation of Liquid Composition for Sulfide Solid Electrolyte-Containing Layer

For the preparation of the liquid composition for the sulfide solid electrolyte-containing layer, octane (available from Tokyo Chemical Industry Co., Ltd.) was used as the solvent. At this time, 10 g of molecular sieve 4A 1/16 (available from Kanto Chemical Co., Inc.) was added per 100 mL of octane, and dehydration was performed by leaving it to rest for 12 hours. It was confirmed that the water content was at most 100 ppm using a Karl Fischer moisture meter. To this solvent (100 parts by mass), 100 parts by mass of the sulfide solid electrolyte synthesized and 1 part by mass of a dispersant (Solsperse™ 21000, available from Lubrizol Corporation) were added and mixed to obtain Liquid Composition 1 for the sulfide solid electrolyte-containing layer.

### Evaluation on Deterioration Reduction Effect on Sulfide Solid Electrolyte-Containing Layer

The obtained Liquid Composition 1 for the sulfide solid electrolyte-containing layer 1 was applied onto Insulating Resin Layer 1, obtained in the section Preparation of Insulating Resin Layer, to an average thickness of 50 μm, and heated and dried at 150 degrees Celsius for 1 hour to form a sulfide solid electrolyte-containing layer. Thereafter, only the sulfide solid electrolyte-containing layer remaining on the insulating resin layer was collected. A total of 60 mg of the obtained sulfide solid electrolyte was placed into a 5 mmφ pelletizer to obtain a pellet under a pressure of 364 MPa and its ionic conductivity was measured. The ionic conductivity of the sulfide solid electrolyte was calculated at an ionic conductivity of 100 percent of the sulfide solid electrolyte not in contact with the insulating resin layer to evaluate the deterioration reduction effect on the sulfide solid electrolyte layer. The number of measurement samples was three, and the average value of these samples was used as the measurement result. It should be noted that a rating of B or above indicates that there are no issues in practical use. The results are shown in Tables 4 to 5.

### Evaluation Criteria for Deterioration Reduction Effect on Sulfide Solid Electrolyte Layer

S: Ionic conductivity is at least 95 percent
A: Ionic conductivity is from 90 percent to less than 95 percent
B: Ionic conductivity is from 80 percent to less than 90 percent
C: Ionic conductivity is less than 80 percent

### Examples 2 to 42 and Comparative Examples 1 to 6

The liquid compositions shown in Tables 1 to 3 were evaluated in the same manner as in Example 1 except that their compositions were changed as shown in Tables 1 to 3. The evaluation results are shown in Tables 4 and 5.

TABLE 4

| | | Insulating resin layer | | Evaluation results | |
|---|---|---|---|---|---|
| | Liquid | Structural | Porous | | Degradation |
| Example | composition | unit 1 | structure | Curling | reduction |
| Example | Liquid | A | A | A | B |
| 1 | composition | | | | |
| | 1 | | | | |
| Example | Liquid | A | A | A | B |
| 2 | composition | | | | |
| | 2 | | | | |
| Example | Liquid | A | A | A | B |
| 3 | composition | | | | |
| | 3 | | | | |
| Example | Liquid | A | A | B | B |
| 4 | composition | | | | |
| | 4 | | | | |
| Example | Liquid | A | A | A | B |
| 5 | composition | | | | |
| | 5 | | | | |
| Example | Liquid | A | A | A | B |
| 6 | composition | | | | |
| | 6 | | | | |
| Example | Liquid | A | A | A | B |
| 7 | composition | | | | |
| | 7 | | | | |
| Example | Liquid | A | A | A | B |
| 8 | composition | | | | |
| | 8 | | | | |
| Example | Liquid | A | A | A | B |
| 9 | composition | | | | |
| | 9 | | | | |
| Example | Liquid | A | A | A | B |
| 10 | composition | | | | |
| | 10 | | | | |
| Example | Liquid | A | A | A | B |
| 11 | composition | | | | |
| | 11 | | | | |
| Example | Liquid | A | A | A | B |
| 12 | composition | | | | |
| | 12 | | | | |
| Example | Liquid | A | A | B | B |
| 13 | composition | | | | |
| | 13 | | | | |
| Example | Liquid | A | A | A | B |
| 14 | composition | | | | |
| | 14 | | | | |
| Example | Liquid | A | A | A | B |
| 15 | composition | | | | |
| | 15 | | | | |
| Example | Liquid | A | A | A | B |
| 16 | composition | | | | |
| | 16 | | | | |
| Example | Liquid | A | A | A | B |
| 17 | composition | | | | |
| | 17 | | | | |
| Example | Liquid | A | A | B | B |
| 18 | composition | | | | |
| | 18 | | | | |
| Example | Liquid | A | A | A | B |
| 19 | composition | | | | |
| | 19 | | | | |
| Example | Liquid | A | A | A | B |
| 20 | composition | | | | |
| | 20 | | | | |
| Example | Liquid | A | A | A | B |
| 21 | composition | | | | |
| | 21 | | | | |
| Example | Liquid | A | A | A | B |
| 22 | composition | | | | |
| | 22 | | | | |
| Example | Liquid | A | A | A | B |
| 23 | composition | | | | |
| | 23 | | | | |
| Example | Liquid | A | A | A | S |
| 24 | composition | | | | |
| | 24 | | | | |

TABLE 5

| | | | | Evaluation results | |
|---|---|---|---|---|---|
| | | Insulating resin layer | | | Degra- |
| | Liquid | Structural | Porous | Curl- | dation |
| Example | composition | unit 1 | structure | ing | reduction |
| Example 25 | Liquid | A | A | A | S |
| | composition 25 | | | | |
| Example 26 | Liquid | A | A | A | S |
| | composition 26 | | | | |
| Example 27 | Liquid | A | A | A | A |
| | composition 27 | | | | |
| Example 28 | Liquid | A | A | A | A |
| | composition 28 | | | | |
| Example 29 | Liquid | A | A | A | B |
| | composition 29 | | | | |
| Example 30 | Liquid | A | A | A | B |
| | composition 30 | | | | |
| Example 31 | Liquid | A | A | A | B |
| | composition 31 | | | | |
| Example 32 | Liquid | A | A | B | B |
| | composition 32 | | | | |
| Example 33 | Liquid | A | A | A | A |
| | composition 33 | | | | |
| Example 34 | Liquid | A | A | A | A |
| | composition 34 | | | | |
| Example 35 | Liquid | A | A | A | A |
| | composition 35 | | | | |
| Example 36 | Liquid | A | A | A | A |
| | composition 36 | | | | |
| Example 37 | Liquid | A | A | A | A |
| | composition 37 | | | | |
| Example 38 | Liquid | A | A | A | A |
| | composition 38 | | | | |
| Example 39 | Liquid | A | A | A | A |
| | composition 39 | | | | |
| Example 40 | Liquid | A | A | A | A |
| | composition 40 | | | | |
| Example 41 | Liquid | A | A | A | A |
| | composition 41 | | | | |
| Example 42 | Liquid | A | A | A | A |
| | composition 42 | | | | |
| Comparative | Comparative | A | C | C | B |
| Example 1 | liquid | | | | |
| | composition 1 | | | | |
| Comparative | Comparative | A | C | C | A |
| Example 2 | liquid | | | | |
| | composition 2 | | | | |
| Comparative | Comparative | A | C | C | A |
| Example 3 | liquid | | | | |
| | composition 3 | | | | |
| Comparative | Comparative | A | C | C | S |
| Example 4 | liquid | | | | |
| | composition 4 | | | | |
| Comparative | Comparative | C | A | A | C |
| Example 5 | liquid | | | | |
| | composition 5 | | | | |
| Comparative | Comparative | C | C | C | C |
| Example 6 | liquid | | | | |
| | composition 6 | | | | |

Based on the results of Examples 1 to 42, it is evident that the laminate for solid state electrochemical elements with the structure according to the present disclosure achieves both curl occurrence reduction due to volume shrinkage and degradation reduction on the sulfide solid electrolyte-containing layer.

As seen in the results of Examples 24 to 28 and Examples 33 to 42, it has been demonstrated that if the polymerizable compound represented by Chemical Formula 3 or Chemical Formula 4 contained in the insulating resin layer contains hydroxypivalic acid neopentyl glycol or a polyester chain, it exhibits superior degradation reduction on the sulfide solid electrolyte-containing layer. Furthermore, if a polycaprolactone chain is included, the degradation reduction on the sulfide solid electrolyte-containing layer is even more pronounced.

As seen in the results of Examples 12 to 13, 17 to 18, and Examples 31 to 32, it has been shown that, if the solvent (good solvent and poor solvent) or polymerizable compound (soluble polymerizable compound and insoluble polymerizable compound) contained in the liquid composition and their respective solubility points satisfy Relationship 1 or Relationship 2, the curl development reduction effect is superior.

In the liquid compositions of Comparative Examples 1 to 4, an insulating resin layer with a porous structure is not formed. Consequently, residual stress due to volume shrinkage cannot be dispersed, and curling occurs in the insulating resin layer.

The insulating resin layers formed from the liquid compositions of Comparative Examples 5 to 6, which contain PEG200DA (PEG200 diacrylate), do not have structural units represented by Chemical Formula 1. As a result, degradation occurs in the sulfide solid electrolyte-containing layer in contact with the insulating resin layer.

### Example 43

### Preparation of Solid State Battery

### Preparation of Active Material

Nickel-based active material (NCM, available from TOSHIMA Manufacturing Co., Ltd.) was used as the positive electrode active material. LiNbO₃ was used as the ion-conductive oxide for surface coating the NCM particles. The LiNbO₃ coating layer was formed by hydrolyzing an alkoxide solution containing lithium and niobium on the surface of NCM powder particles, based on J. Mater. Chem. A. 2021, 9, 4117-4125. One specific method is as follows.

First, an ethanol solution of lithium ethoxide was prepared by dissolving metallic lithium (available from Honjo Metal Co., Ltd.) in anhydrous ethanol (Kanto Chemical Co., Inc.). Niobium pentaethoxide (Nb(OC₂H₅)₅, available from KOJUNDO CHEMICAL LABORATORY CO., LTD.) was then added to this solution to form an alkoxide solution containing lithium and niobium. Using a rolling fluidized bed device, NCM1 powder was made into a fluidized bed, and the alkoxide solution was sprayed, thereby obtaining a precursor powder in which the surface of the NCM powder particles was coated with alkoxide. This precursor powder was then heated at 350 degrees Celsius under a dry air atmosphere, resulting in the synthesis of LNO/NCM, in which the LiNbO₃ layer was formed on the surface of NCM1.

### Preparation of Positive Electrode

LNO/NMC (45.3 percent by mass) as a positive electrode material was dispersed in anisole (36.4 percent by mass, available from Tokyo Chemical Industry Co., Ltd.) along with acetylene black (2.2 percent by mass, available from DENKA Co., Ltd.) as a conductive material, polybutyl methacrylate (PBMA, available from Aldrich Co., Ltd.) as a binder (1.4 percent by mass), and sulfide solid electrolyte (14.7 percent by mass), forming a positive electrode paint.

This positive electrode paint was applied to both sides of an aluminum foil substrate and dried to obtain a 20 mm×20 mm positive electrode. The average thickness was 95 μm, and the battery capacity per unit area was 2.91 mAh/cm².

### Preparation of Negative Electrode

On a stainless steel foil, a lithium metal with an average thickness of 50 μm (available from Honjo Metal Co., Ltd.) was attached. Additionally, a 50 μm thick indium foil (available from The Nilaco Corporation) was laminated on top to obtain a 25 mm×25 mm negative electrode.

### Fabrication of Solid State Battery

The liquid composition of Example 1 was filled into an inkjet discharging device equipped with a GEN5 head (available from Ricoh Printing Systems Ltd.).

The positive electrode was placed on a stage, and the liquid composition was applied such that the distance between the outer periphery of the positive electrode and the insulating resin layer was 0.5 mm. The coated area was then immediately exposed to UV light under a nitrogen atmosphere (light source: UV-LED (available from Phoseon Technology, product name: FJ800), wavelength: 365 nm, irradiation intensity: 30 mW/cm², irradiation time: 20 s) to cure the coating. Next, using a hot plate, the cured material was heated at 120 degrees C. for 1 minute to remove the solvent, forming the positive electrode-insulating resin layer.

At this stage, the average thickness of the insulating resin layer was 124 μm, and the curl of the insulating resin layer was 2.3 mm.

After the positive electrode-insulating resin layer with aluminum laminate was sealed, it was pressurized at 500 MPa for 5 minutes using a cold isostatic press (CIP). After the pressurization, the positive electrode-insulating resin layer was removed from the aluminum laminate.

The liquid composition for the sulfide solid electrolyte-containing layer was applied to the positive electrode by the bar coating method. After coating, it was sealed again with aluminum laminate and pressurized at 500 MPa for 5 minutes using the CIP. The positive electrode-insulating resin layer and the negative electrode were placed facing each other, with lead wires attached to each. The assembly was then vacuum-sealed using a laminate, forming a solid state battery.

The voltage of the fabricated solid state battery was measured to be 2.05 V. The solid state battery was able to be stably charged without short circuits at a constant current up to 3.6 V with a current value corresponding to 20 percent of the theoretical capacity per unit area of the positive electrode active material.

### Method of Measuring Capacity Per Unit Area

The capacity per unit area of the electrode was measured using a charge-discharge measurement device TOSCAT 3001 (available from TOYO SYSTEM CO., LTD.)

First, the electrode fabricated electrode was punched into a 10 mm diameter circular shape.

The capacity of the positive electrode containing the solid electrolyte was evaluated using the following method:

In an argon atmosphere, the positive electrode was punched into a 10 mm diameter circular electrode at capacity per unit area.

After 80 g of sulfide solid electrolyte was placed into a polyethylene terephthalate (PET) tube of a two-electrode cell (available from Housen Corp.), a pressing pin was placed on top, and the assembly was molded at a displayed pressure of 10 MPa for 1 minute using a uniaxial press machine (P-6, available from RIKEN SEIKI). Next, the 10 mm diameter punched positive electrode was placed such that the active material surface was in contact with the sulfide solid electrolyte inside the PET tube, a pressing pin was set, and the assembly was molded at a displayed pressure of 30 MPa for 1 minute using the uniaxial press machine.

A structure consisting of lithium (available from Honjo Metal Co., Ltd.) with an average thickness of 50 μm and indium (available from Niraco Co., Ltd.) with an average thickness of 50 μm laminated on an SUS foil with an average thickness of 10 μm was placed on the opposite side of the positive electrode composite layer. This assembly was then molded at a displayed pressure of 12 MPa for 3 seconds using the uniaxial press machine. The PET tube with the pressing pin on was placed into the two-electrode cell and sealed at a displayed pressure of 25 N·m using a digital torque ratchet (KTC Tool) to fabricate an electrochemical element.

This electrochemical element was subjected to initial charge-discharge testing at room temperature (25 degrees Celsius) by charging to 3.6 V with a constant current corresponding to 20 percent of the capacity per unit area calculated from the theoretical capacity of the positive electrode active material, and then discharging to 2.4 V at a constant current. This initial charge-discharge process was repeated two times, and the discharge capacity of the second cycle was measured as the initial capacity per unit area of the positive electrode.

Aspects of the present disclosure include, but are not limited to the following:

### Aspect 1

A laminate for a solid state electrochemical element contains a sulfide solid electrolyte-containing layer and an insulating resin layer at least partially in contact with the sulfide solid electrolyte-containing layer, wherein the insulating resin layer has a porous structure and comprises a structural unit represented by the following Chemical Formula 1 or Chemical Formula 2,

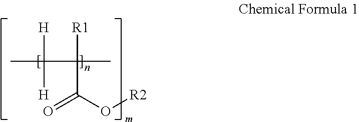

where R1 represents a hydrogen atom or a methyl group and R2 represents a polyester chain or an acrylic oligomer ester derivative,

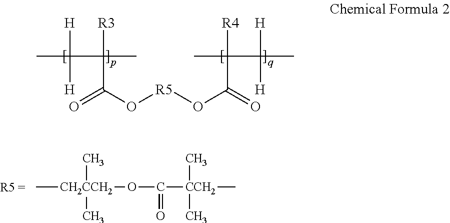

where R3 and R4 each, independently, represent hydrogen atoms or methyl groups.

### Aspect 2

The laminate according to Aspect mentioned above, wherein the structural unit is represented by Chemical Formula 1 with R2 being the polyester chain or by Chemical Formula 2.

### Aspect 3

The laminate according to Aspect 1 mentioned above, wherein R2 represents the polyester chain.

### Aspect 4

The laminate according to Aspect 1 or 2 mentioned above, wherein R2 represents a polycaprolactone chain.

### Aspect 5

The laminate according to Aspect 1 or 2 mentioned above, wherein the insulating resin layer further contains a cured liquid composition and a solvent, the cured liquid composition comprising a polymerizable compound represented by Chemical Formula 3 or Chemical Formula 4,

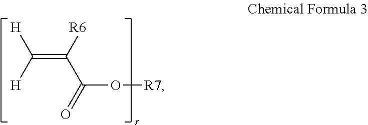

where R6 represents a hydrogen atom or a methyl group, R7 represents a polyester chain or an acrylic oligomer ester derivative,

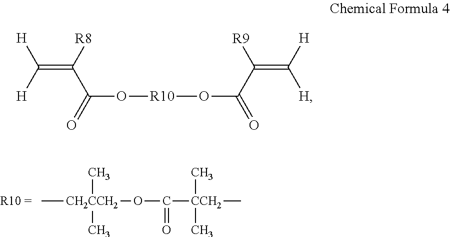

where R8 and R9 each, independently, represent hydrogen atoms or methyl groups, the solvent comprising a solvent mixture comprising a good solvent that dissolves the polymerizable compound and a poor solvent that leaves the polymerizable compound undissolved, the solvent satisfying the following Relationship 1,

Polymerizable compound soluble point≤Mixing ratio X<Polymerizable compound soluble point+11 Relationship 1
where the mixing ratio X represents a content ratio by percentage based on a mass of the good solvent in the solvent mixture, and the polymerizable compound soluble point represents a minimum content ratio by percentage based on the mass of the good solvent in the solvent mixture.

### Aspect 6

The laminate according to Aspect 1 or 2 mentioned above, wherein the insulating resin layer further comprises a cured liquid composition and a solvent, the cured liquid composition comprising a polymerizable compound represented by Chemical Formula 3 or Chemical Formula 4,

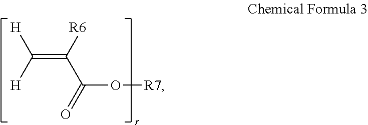

where R6 represents a hydrogen atom or a methyl group, R7 represents a polyester chain or an acrylic oligomer ester derivative,

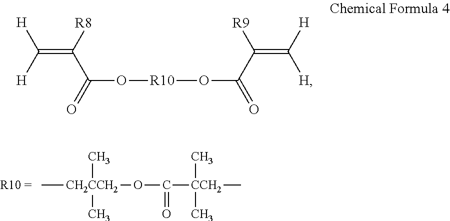

where R8 and R9 each, independently, represent hydrogen atoms or methyl groups, the polymerizable compound comprising a compound mixture comprising a soluble polymerizable compound soluble to the solvent and an insoluble polymerizable compound insoluble to the solvent, the polymerizable compound satisfying the following Relationship 2,

Solvent soluble point≤Mixing ratio Y<Solvent soluble point+21 Relationship 2
where the mixing ratio Y represents a content ratio by percentage based on a mass of the insoluble polymerizable compound in the compound mixture, and the solvent soluble point represents a minimum content ratio by percentage based on the mass of the insoluble polymerizable compound in the compound mixture.

### Aspect 7

The laminate according to Aspect 1 or 2 mentioned above, wherein the insulating resin layer has a co-continuous structure.

### Aspect 8

The laminate according to Aspect 1 or 2 mentioned above, wherein the insulating resin layer has an average thickness between 1.0 μm and 150.0 μm.

### Aspect 9

The laminate according to Aspect 1 or 2 mentioned above, wherein the insulating resin layer has a porosity of at least 30 percent.

### Aspect 10

The laminate according to Aspect 1 or 2 mentioned above, further comprising a substrate, wherein the sulfide solid electrolyte-containing layer is disposed on the substrate, and the insulating resin layer is disposed on an outer peripheral of the sulfide solid electrolyte-containing layer, and the sulfide solid electrolyte-containing layer comprises an electrode composite layer comprising an active material.

### Aspect 11

The laminate according to Aspect 1 or 2 mentioned above further includes a substrate and an electrode composite layer, wherein the sulfide solid electrolyte-containing layer is disposed on the electrode composite layer, and the insulating resin layer is disposed at least partially in contact with the sulfide solid electrolyte-containing layer.

### Aspect 12

The laminate according to Aspect 11 mentioned above further includes an adhesive layer disposed between the substrate and the electrode composite layer, the adhesive layer comprising a metal alloyed with lithium.

### Aspect 13

The laminate according to Aspect 12 mentioned above, wherein the electrode composite layer has an opening.

### Aspect 14

The laminate according to Aspect 13 mentioned above, wherein a sulfide solid electrolyte is filled into the opening.

### Aspect 15

A solid state electrochemical element contains the laminate of Aspect 1 or 2 mentioned above.

### Aspect 16

The solid state electrochemical element according to Aspect 15 mentioned above is a solid state battery.

### Aspect 17

An electric device comprising the solid state electrochemical element of Aspect 16 mentioned above.

### Aspect 18

A mobile object comprising the solid state electrochemical element of Aspect 16 mentioned above.

### Aspect 19

The mobile object according to Aspect 18 mentioned above is a vehicle.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A laminate for a solid state electrochemical element, comprising:
a sulfide solid electrolyte-containing layer; and
an insulating resin layer at least partially in contact with the sulfide solid electrolyte-containing layer,
wherein the insulating resin layer has a porous structure and comprises a structural unit represented by the following Chemical Formula 1 or Chemical Formula 2, 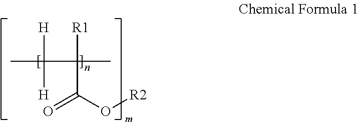
where R1 represents a hydrogen atom or a methyl group and R2 represents a polyester chain or an acrylic oligomer ester derivative, 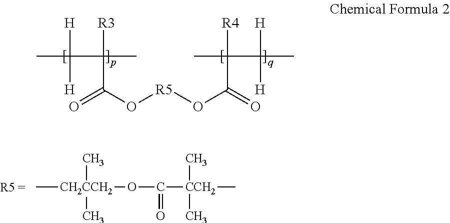
where R3 and R4 each, independently, represent hydrogen atoms or methyl groups.

2. The laminate according to claim 1, wherein the structural unit is represented by Chemical Formula 1 with R2 being the polyester chain or by Chemical Formula 2.

3. The laminate according to claim 1,
wherein R2 represents the polyester chain.

4. The laminate according to claim 1,
wherein R2 represents a polycaprolactone chain.

5. The laminate according to claim 1,
wherein the insulating resin layer further comprises a cured liquid composition and a solvent, the cured liquid composition comprising a polymerizable compound represented by Chemical Formula 3 or Chemical Formula 4, 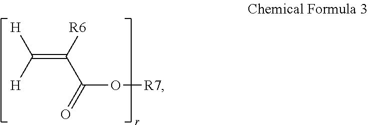
where R6 represents a hydrogen atom or a methyl group, R7 represents a polyester chain or an acrylic oligomer ester derivative, 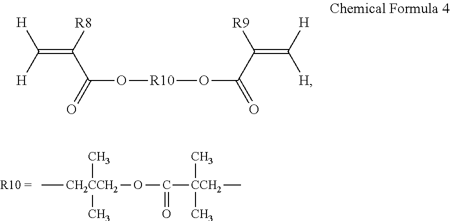
where R8 and R9 each, independently, represent hydrogen atoms or methyl groups, the solvent comprising a solvent mixture comprising a good solvent that dissolves the polymerizable compound and a poor solvent that leaves the polymerizable compound undissolved, the solvent satisfying the following Relationship 1,
Polymerizable compound soluble point≤Mixing ratio X<Polymerizable compound soluble point+11 Relationship 1
where the mixing ratio X represents a content ratio by percentage based on a mass of the good solvent in the solvent mixture, and the polymerizable compound soluble point represents a minimum content ratio by percentage based on the mass of the good solvent in the solvent mixture.

6. The laminate according to claim 1, wherein the insulating resin layer further comprises a cured liquid composition and a solvent, the cured liquid composition comprising a polymerizable compound represented by Chemical Formula 3 or Chemical Formula 4, 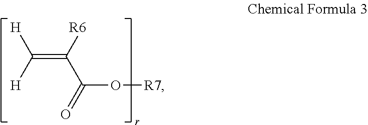
where R6 represents a hydrogen atom or a methyl group, R7 represents a polyester chain or an acrylic oligomer ester derivative, 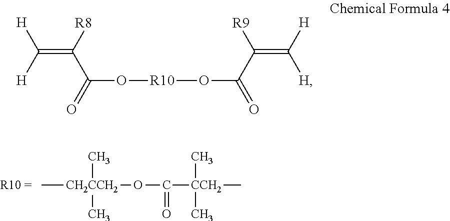
where R8 and R9 each, independently, represent hydrogen atoms or methyl groups, the polymerizable compound comprising a compound mixture comprising a soluble polymerizable compound soluble to the solvent and an insoluble polymerizable compound insoluble to the solvent, the polymerizable compound satisfying the following Relationship 2,
Solvent soluble point≤Mixing ratio Y<Solvent soluble point+21 Relationship 2
where the mixing ratio Y represents a content ratio by percentage based on a mass of the insoluble polymerizable compound in the compound mixture, and the solvent soluble point represents a minimum content ratio by percentage based on the mass of the insoluble polymerizable compound in the compound mixture.

7. The laminate according to claim 1, wherein the insulating resin layer has a co-continuous structure.

8. The laminate according to claim 1, wherein the insulating resin layer has an average thickness between 1.0 μm and 150.0 μm.

9. The laminate according to claim 1, wherein the insulating resin layer has a porosity of at least 30 percent.

10. The laminate according to claim 1, further comprising a substrate,
wherein the sulfide solid electrolyte-containing layer is disposed on the substrate,
the insulating resin layer is disposed on an outer peripheral of the sulfide solid electrolyte-containing layer, and
the sulfide solid electrolyte-containing layer comprises an electrode composite layer comprising an active material.

11. The laminate according to claim 1, further comprising:
a substrate; and
an electrode composite layer on the substrate,
wherein the sulfide solid electrolyte-containing layer is disposed on the electrode composite layer, and
the insulating resin layer is disposed at least partially in contact with the sulfide solid electrolyte-containing layer.

12. The laminate according to claim 11, further comprising an adhesive layer disposed between the substrate and the electrode composite layer, the adhesive layer comprising a metal alloyed with lithium.

13. The laminate according to claim 12,
wherein the electrode composite layer has an opening.

14. The laminate according to claim 13,
wherein a sulfide solid electrolyte is filled into the opening.

15. A solid state electrochemical element comprising the laminate of claim 1.

16. The solid state electrochemical element according to claim 15, being a solid state battery.

17. An electric device comprising the solid state electrochemical element of claim 16.

18. A mobile object comprising the solid state electrochemical element of claim 16.

19. The mobile object according to claim 18, being a vehicle.
